(19) United States
(12) Patent Application Publication
(10) Pub. No.: US 2026/0295334 A1
(43) Pub. Date: Oct. 1, 2026

(54) APPARATUS FOR, AND A COMPUTER IMPLEMENTED METHOD OF, IMPROVING A GOLF SWING

(71) Applicant: Brian Francis MOONEY, Dún Laoghaire (IE)

(72) Inventor: Brian Francis MOONEY, Dún Laoghaire (IE)

(21) Appl. No.: 19/477,062

(22) PCT Filed: Apr. 29, 2024
(86) PCT No.: PCT/EP2024/061800

§ 371 Date: Oct. 20, 2025

(30) Foreign Application Priority Data
Apr. 27, 2023 (IE) S2023/0131

(51) Int. Cl. A63B 24/00; A63B 71/06; A63B 102/32

(52) U.S. Cl. CPC A63B 24/0006; A63B 71/0622; A63B 2024/0009; A63B 2071/0625; A63B 2102/32

(57) ABSTRACT

An encapsulated dual-camera apparatus (19), with machine-learning 3D motion-capture and machine-learning measurement of energy generation within the body, captures live data on a player's (1) non-putting golf swing. Feedback from the energy generation data is used to drive a highly novel directed discovery learning process. The energy generation approach strongly resonates with the player's subconscious system and rapidly overcomes its usual vehement resistance to experiment with and discover new and improved subconscious movement patterns. This allows the apparatus to scientifically and methodically direct it to successfully discover and adopt ever-intensifying increases in swing strength, accuracy and consistency. The apparatus is fully automatic, easy to use and operates without body sensors or special clothing. It can be optionally used with a real (3) or virtual ball.

### CONTENTS

### Alphabetic Glossary of Acronyms and Special Terms

1.0 Introduction.
1.1 Discussion.
1.2 Prior Art.
2.0 Generalised Characteristics of the Invention in the Golf Swing.
3.0 Examples where the Motion Sequence is a Non-Putting Golf Swing.
3.1 Description of a Computer-implemented Method.
3.1.1 Brief Summary.
3.1.2 Definitions and Abbreviations.
3.1.3 Discovery Learning in Non-Putting or Distance Swings.
3.2 Detailed Example of a Computer-implemented Discovery Learning Method.
3.2.1 Overview.
3.2.2 Upwardly disrupting Discovery (UDD) Processes.
3.2.2.1 UDD Parameter Selection in a Session.
3.2.2.2 UDD Instructions.
3.2.2.3 UDD Booster Actions.
3.2.2.4 UDD Execution and Feedback.
3.2.2.5 Continuation Criteria and Further Directions.
3.2.3 Tempering Discovery (TD) Processes.
3.2.3.1 Background
3.2.3.2 TD Instruction.
3.2.3.3 TD Execution and Feedback.
3.2.4 Intermingling UDD and TD Swing Sets.
3.2.5 Intrinsic Requirement for Automatic Operation.
3.2.6 Other Conditions which assist UDD.
3.2.7 Other Session Activities.
3.2.7.1 Overview.
3.2.7.2 Grounding Swings.
3.2.7.3 Address-Training-Interventions and First-time Address Instructions.
3.2.7.4 UDD-Training-Interventions and First-time Swing Instructions
4.0 Home-use Examples of Apparatus.
4.1 First Described Embodiment.
4.1.1 Further Details of the Apparatus.
4.1.1.1 The PE System.
4.1.1.2 3D Model Tracking System.
4.1.1.3 Kinetic Parameter Prediction System.
4.1.1.4 Preparation of Training Databases.
4.1.1.5 Clubhead speed measurement.
4.1.1.6 Processing the Measured Data.
4.2 Second Described Embodiment.
4.3 Third Described Embodiment.
5.0 Use in Commercial and Elite Applications.
6.0 Alternative Methods of Motion Capture.
7.0 Summary of Key Advantages over Coaching Techniques and Apparatus.
8.0 Motion Sequences other than Non-Putting Golf Swings.

### Alphabetic Glossary of Acronyms and Special Terms

“Address-Training-Intervention” An intervention which corrects address errors and which contains some coaching-type aspects.
“AR/VR” Virtual reality, immersive technology or spatial computing system, including AR, VR, MR and XR.
“Body component” Body component, such as a joint, directly related to no more than about one third of downswing energy generation.
“Booster action” An action intended to cause a magnitude increase in a specific body component energy generation parameter.
“CKI” Clubhead Kinetic energy immediately prior to Impact.
“Coached process” Teaching process where a student is instructed to replicate specific movement skills.
“Discovery-learning” Learning process where a student is directed towards using his or her own abilities to independently discover and learn new subconscious movement patterns.
“Efficiency” Ratio of (Total-PED)/(CKI).
“Energy generation parameter” Parameter related to energy generation in a golf swing or similar motion sequence.
“FT” Follow-through, final stage following impact.
“Geometric angular displacement” Angular displacement of a joint in a downswing, whether positive energy is being generated or not.
“HPE” Human Pose Estimation. A computer vision system that detects and tracks key points in the human body.

“Into FT” Through impact and into the follow-through.

“Joint energy” Energy generated across a joint.

“Machine-learning” Also termed “machine learning”. Type of artificial intelligence which is trained.

“Measuring” Measuring, determining, predicting or estimating.
“OPE” Object Pose Estimation. A computer vision system that detects and tracks key points in an object.
“PE” Pose Estimation, including HPE and/or OPE.
“PED” Positive Energy generated across a joint in a Downswing.
“PED AD” Angular Displacement component of a PED.
“PED AT” Average Torque component of a PED.
“PED onset” Measure of the start or “onset” of a PED, usually an angle related to the inclination of the club shaft.
“TD swing” A swing where TD occurs or has occurred.
“TD” process. Tempering discovery process. Part of a learning discovery process.
“TOB” Top-of-backswing, position in the swing.
“Total PED” Sum of all PEDs in a downswing.
“UDD” process. Upwardly disrupting discovery process. Part of a learning discovery process.
“UDD swing” A swing where UDD occurs or has occurred.
“UDD-Training-Intervention” An intervention which corrects backswing and downswing errors while the swing is upwardly disrupted and which contains some coaching-type aspects.
“Virtual-ball-target” A target which replaces a ball in the tee position.

### SUMMARY OF THE INVENTION

### 1.0 Introduction

### 1.1 Discussion

The present invention provides an apparatus and computer-implemented method for improving a non-putting golf swing or similar motion sequence where the motion sequence includes a brief, high-speed, high-energy element and where “improving” means a selection from improving strength, improving strength and accuracy and improving strength accuracy and consistency.

The term “brief”, should be understood to mean having a duration of less than about one or two seconds, the term “high-speed”, should be understood to indicate that it involves a body part, implement or projectile which travels at a speed which make it difficult to consciously control in real time, and the term “high-energy” should be understood to mean that it involves energy-generation from wide-ranging upper-body and lower-body muscles, at levels which normally could not be upheld for an appreciable period, certainly not more than ten seconds. In the golf swing, the high-energy element comprises the downswing and its duration is usually less than one third of a second.

More particularly, the present invention provides an apparatus and computer-implemented method used in improving a non-putting golf swing, or similar motion sequence, using discovery learning processes. Discovery learning fundamentally differs from coached learning, rather than being instructed to replicate specific movement skills, the student or player is directed towards using his or her own abilities to independently discover and learn new subconscious movement patterns. The discovery learning processes used in the present invention, appear to differ from those currently recognised in prior art.

### 1.2 Prior Art

WO 2020/074596 A1 discloses a method and apparatus directed, inter alia, towards directly coaching the strength of a golf downswing using inverse-dynamics techniques to determine kinetic parameters. It comprises a computing means, measuring means and feedback means. It is expressly confined to coaching techniques. It includes a planning stage where low-strength, underperforming energy generation and transmission parameter components are identified and targeted for strength-coaching. Following the planning stage, it strives to build-up a swing of greater strength, with particular energy generation or transmission components being targeted and increased in strength one-at-a-time, while all other energy generation and transmission components are left unchanged. It advocates avoiding all references to body parts, joints and segments, when giving coaching or communicating instructions, but instead focuses on intended end results, such as increasing ball travel distance. It recommends that where mention of body joints or segments is unavoidable, it should ideally be isolated well in advance of coaching practice, even to several days prior to practice coaching. The method also recommends avoiding verbal or repetitive feedback. Its techniques are expressly confined to the downswing portion of the swing.

### 2.0 Generalised Characteristics of the Invention in the Golf Swing

A player's decision-making and action in the downswing of a golf swing is organised, or largely organised, by the player's sub-conscious, due to the very short period over which a range of complex body movements takes place. Throughout the specification, the player's system involved in organising body movement on a subconscious level may be termed the player's “subconscious self-organising system” or “subconscious”. For brevity and ease of expression, terms related to “disrupt”, “stimulate”, “explore”, “reject”, “overcome resistance to”, “resonate with”, or such similar terms, may be applied to the subconscious self-organising-system where the effects or outcomes appear similar or equivalent to effects experienced with the player's conscious mind, although the intimate operation of the human subconscious self-organising-system or subconscious is not fully understood either now or in prior art.

A basic step used in the computer-implemented method of the invention involves use of an apparatus to upwardly disrupt an energy generation parameter in the downswing, where “upwardly” is understood in the sense of increasing energy generation levels. Partly because the inner workings of the subconscious can only be inferred by observation of the results, such upward disruption produces a result which can be expressed in various ways, including the following:
it strongly resonates with the player's self-organising-system and rapidly overcomes its usual vehement resistance to experiment and discover new and improved subconscious movement patterns;
it stimulates or causes the player's subconscious self-organising-system to explore changes in its current subconscious movement patterns used in executing the downswing;
it reduces the resistance of the player's subconscious self-organising-system to make or explore changes in its current subconscious movement patterns used in executing the downswing;
it disrupts and causes the player's subconscious self-organising-system to explore upward changes in its current subconscious movement patterns used in executing the downswing;
it disrupts and causes the player's subconscious self-organising-system to use increased new or different combinations of movement patterns in executing the downswing; and
it uses selective targeting of increases in small components of larger movement-sequence patterns to stimulate the subconscious self-organising-system to change its movement-patterns.

Upwardly disrupting parameters will typically have the following characteristics. They are related to energy generated internally in the downswing. They need not necessarily in themselves be targets for discovery learning improvement and very frequently are not. The energy generated to which they are most closely related should normally represent no more than a minority or small part of the total energy generated in the downswing. Their increases are related, or associated with, increases in total energy generated internally in the downswing.

### 3.0 Examples where the Motion Sequence is a Non-Putting Golf Swing

### 3.1 Description of a Computer-Implemented Method

### 3.1.1 Brief Summary

An automatic apparatus strongly and rapidly upwardly disrupts a player's ingrained swing movement patterns in a non-putting golf swing, quickly overcoming the usual vehement resistance of the player's subconscious self-organising-system to change the ingrained patterns. The changes are directed towards ever-increasing internal energy generation in the player's downswing. A key element is selective targeting of increases in small components of larger swing movement patterns, which strongly resonates with the player's subconscious self-organising-system when presented in a particular manner. This, together with very intimate intermingling of interrupting and tempering processes allows the apparatus to scientifically and methodically direct it to successfully discover and adopt ever-intensifying increases in swing strength, accuracy and consistency. The interrupting and tempering processes are described in detail later in the specification.

The apparatus measures relevant components of the player's energy generation and transmission in the swing. These measurements are used both to provide discovery learning feedback and to maintain ongoing records of swing development.

### 3.1.2 Definitions and Abbreviations

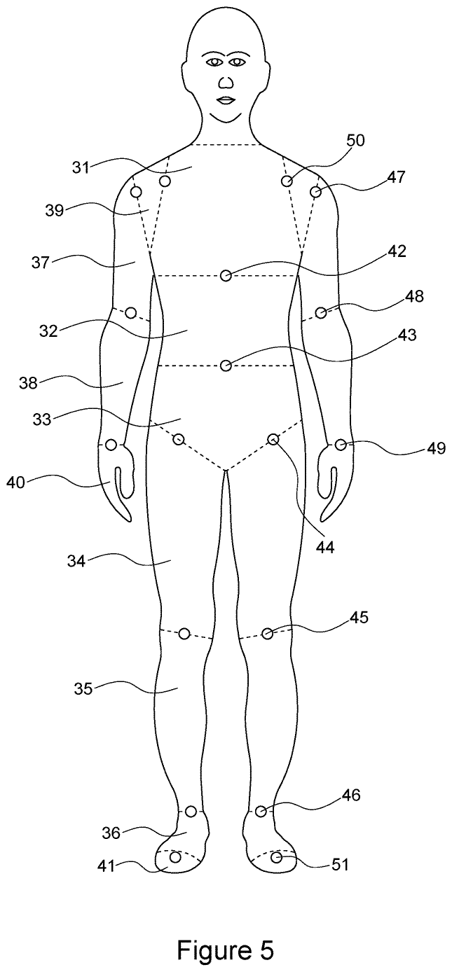

For the sake of brevity and convenience, henceforth throughout this specification, an individual executing a golf swing shall be referred to as a “player”, the terms “he” or “his” shall refer equally to male or female players, and the term “swing” or “golf swing” shall refer to a non-putting golf swing. Players shall also be assumed to strike the ball in the most common direction from their right to their left side, although a mirror image of the principles will apply exactly the same to players who strike the ball in a direction from their left to their right sides. The adjective “kinematic” should be understood as dealing largely with motion without any reference to force, torque, power or energy. The adjective “kinetic” should be understood as dealing largely with motion with reference to force, torque, power or energy.

Where reference is made to a “model” or “skeletal model” of the player, it shall refer to a model comprising rigid segments connected by joints. A model, of the type used in the example, is shown in FIG. 5. Referring now to FIG. 5, segment boundaries are indicated by dashed lines and joints are indicated by small unfilled circles. An index of reference numerals, used in FIG. 5, is shown below. For clarity, reference numbers for segments on the player's left side and joints on the player's right side are omitted in the figure.
31. Upper torso (segment)
32. Middle torso (segment)
33. Pelvis (segment)
34. Right upper leg (segment)
35. Right lower leg (segment)
36. Right foot (segment)
37. Right upper arm (segment)
38. Right lower arm (segment)
39. Right upper torso (segment).
40. Right hand (segment)
41. Right toes (segment)
42. Thorax (joint)
43. Lumbar (joint)
44. Left hip (joint)
45. Left knee (joint)
46. Left ankle (joint)
47. Left shoulder (joint)
48. Left elbow (joint)
49. Left wrist (joint)
50. Left shoulder-girdle (joint)
51. Left toes joint (joint)

The model is shown without the gripped club. A single grip joint, which is not shown in the figure, can be used between the hands and club. Alternatively, a simpler arrangement can be used with the wrist joints and hand segments omitted and a single joint shown appropriately between extensions of the lower arm segments and the club, with the mass of the hands being distributed between the lower arms and the club. Other common simplifications of the model include the following. The toe joints can be eliminated by appropriately omitting either toe joint and treating the foot and toe segments as a single segment. The ankle and toe joints can be eliminated by appropriately omitting them and treating the lower leg, foot and toe segments as a single segment. Similarly, the shoulder girdle joint can be omitted by treating the upper torso and left or right upper torso as a single segment. Where joints are omitted in this manner, inverse dynamics calculations automatically attribute no forces at actual joints between the combined segments, and instead distribute the inertial parameters and forces around the joints which are treated separately.

In addition to referring to the articulations in the body model, the term “joint”, or a named joint, shall also be used to refer to the joint and its associated muscle group or to activities associated with that joint. For example, left knee joint energy refers to the energy generated across the left knee by the muscle groups acting about the left knee joint. Also, throughout the specification it shall also refer only to energy generated at the joint rather than energy transmitted across or through the joint. It should be noted that energy generated across a joint, referred to as “joint energy” and energy transmitted across a joint, are two entirely different parameters.

Positive joint energy generated in the downswing may be referred to as “PED” and joint energy absorbed in the downswing may be referred to as negative generated energy. The magnitude value of the sum of all PEDs in a swing may be referred to as “total PED”. A PED may also be expressed as a product of two particular components, relevant angular displacement and relevant torque. The relevant angular displacement is referred to as the “kinetic angular displacement” or “PED-AD” of the relevant joint. The average value of torque over the PED, may be referred to as the “PED-AT”, and is frequently used as the relevant torque where the PED is “trimmed”. The term “trimmed” is explained later.

Throughout this specification, the terms PED, PED-AD and PED-AT should be understood to apply equally to complete or trimmed parameters, unless the context suggests otherwise. The ordinary geometric angular displacement of a joint, without regard to whether torque is positive or negative and assists or retards the angular displacement, will be referred to as the “geometric angular displacement”. For any particular joint, the PED-AD is frequently smaller than the geometric angular displacement and occurs within the geometric angular displacement. Other portions of the geometric angular displacement may be involved in energy absorption or may not be involved in any energy generation or absorption.

The anatomical positions of the joints and segment boundaries are generally similar to those disclosed in prior art document WO2013/041444, other than the ball-of-foot joint which lies approximately between the toes and metatarsal bones of the foot, and also the boundaries between a foot segment and toes segment, which may comprise a plane through the foot joint, parallel to the frontal or coronal plane when the model is in a standing position with feet flat on the ground.

The terms “address”, “takeaway”, “top-of-backswing” (“TOB”), “downswing”, “impact”, “follow-through” and “target line” are the same as those normally used in golf parlance.

Throughout the specification, where reference is made to actions by a processor, these should normally be understood to mean actions by an electronic processor using software.

It should also normally be understood that appropriate and relevant algorithms are used within the software where required, although these will not usually be specifically stated and explained unless the required algorithm is one that would not be capable of implementation by those skilled in the art. Also, where a reference is made to a processor or system processor, this should normally be understood to refer to one or a plurality of processors, and to processors located within the apparatus or located remotely from the apparatus. Where reference is made to data being available to a processor or system, this may refer to data being available from memory means within the processor or memory means accessible from a remote location. It may also refer to data which is not held in memory, but is accessible in other ways, including being calculated by a processor when requested. It may also refer to data which is obtained from a database which is regularly changed or updated.

### 3.1.3 Discovery Learning in Non-Putting or Distance Swings

An accurate non-putting or distance golf swing is not a natural human movement. It requires a complex combination of subconscious movement patterns. It appears that when a player first obtains the knack of hitting a reasonable golf swing, his subconscious self-organising system usually becomes largely satisfied with this first combination of movement patterns. Thereafter, it becomes more difficult for the player to consciously change this movement pattern, although persistent, regular practice and coaching of some type or other may slowly, improve the movement patterns and level of accomplishment.

Several impediments appear to prevent the typical player achieving anything but very slow improvement in his non-putting swing, and especially his non-putting distance swing. First, although the player is consciously very aware of what the final overarching outcome of the swing should be, he has no conscious understanding at all as to how his subconscious self-organising-system can organise and very rapidly execute the required all-body processes which result in the required higher clubhead speed. Second, because he probably has already made a significant investment in time to achieve his then current level of skill, he will be wary of making any dramatic changes which could cause him to lose what he has already achieved. Usually, other than an attempt to hit the ball harder, he will be unwilling to risk anything other than very small changes which he feels he can backtrack on if they prove unsuccessful. Third, when the player tries to increase distance and accuracy, the small incremental increases which can potentially be made in distance or accuracy from swing-to-swing are typically swamped by other larger variables in swing distance and accuracy. This occurs even where he has some overall numerical feedback on results, for example on a driving range where the trajectory is tracked by a tracking device. Fourth, there is a mismatch between what the player's subconscious self-organising-system and the player's conscious will try to achieve in the high-speed portion of a swing which requires a new set of subconscious swing movement patterns, partly because the distance swing is not a natural human action. The player is typically completely unaware as to how he can influence his subconscious self-organising-system in achieving his overall targets. Fifth, the vital and complex downswing portion of the distance swing is achieved in about one third of a second. This is far too fast to be manipulated or controlled by the player's conscious awareness and the player is entirely dependent on his subconscious self-organising-system to execute the movement.

The present invention provides a method and apparatus which rapidly and successfully upwardly disrupts the player's subconscious self-organising-system in a discovery learning process, to overcome its resistance to breaking away from its existing set of swing movement patterns and explore new or modified sets of movement patterns in a manner which leads to a non-putting or distance swing of greater strength and greater or equal accuracy.

### 3.2 Detailed Example of a Computer-Implemented Discovery Learning Method

### 3.2.1 Overview

A particular embodiment is described which involves a discovery learning session using an example of the apparatus and computer-implemented method of the invention. A player executes discovery learning swings with a driver or similar club. Using the same apparatus, a real ball or substitute virtual ball target may be hit. For clarity, substitute virtual ball target may also be referred to as a “virtual-ball-target”. The apparatus operates automatically, without the assistance of a human coach or other person. The example method and apparatus can be automatically and successfully used by players ranging from beginner to highly accomplished. The example describes a swing with a driver or similar club but can be used with any non-putting club.

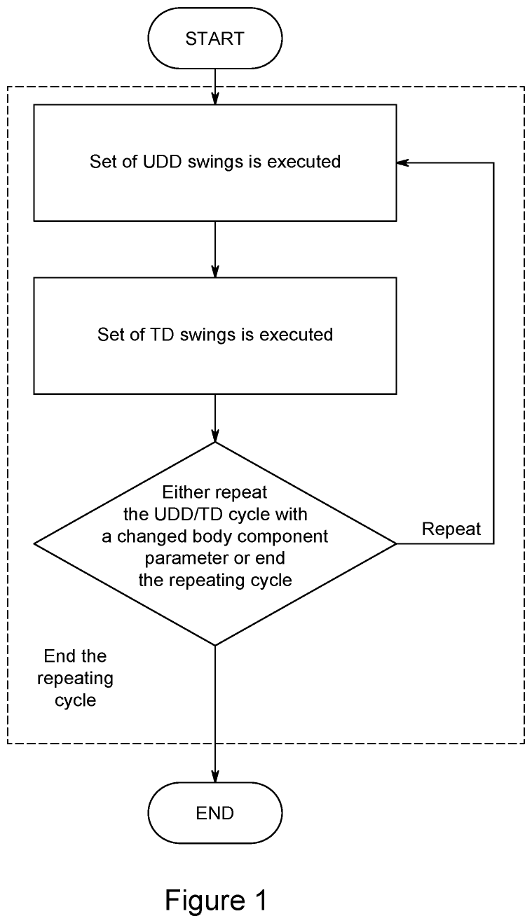

Reference is made to FIG. 1 which shows a flow chart summarising key steps in the example. The steps are controlled by the apparatus and comprise a repeating cycle of “upwardly disrupting discovery” (“UDD”) swings, and “tempering discovery” (“TD”) swings. These terms are discussed in detail over following paragraphs.

The essence of the method involves the use of a repeating learning cycle of UDD and TD swings. The UDD process achieves the very difficult task of overcoming the “resistance” of the subconscious self-organising-system to break out of its established subconscious movement patterns. Where the UDD process is used alone, the breakout from established subconscious movement patterns can frequently lack proper direction, and the UDD process can effectively be rejected by the subconscious self-organising-system after use in several consecutive swings. The TD process, when used alone, is unable to successfully overcome the apparent resistance of the subconscious self-organising-system to significantly break out of its established subconscious movement patterns to any appreciable degree within a required short or medium time frame. However, where a breakout has been achieved by the UDD process, the TD process is capable of maintaining the breakout over further swings which are executed without undue delay. Furthermore, where UDD and TD are closely intermingled, for example by repeatedly cycling these steps, with regular changes in body components, as shown in FIG. 1, changed subconscious movement patterns with improved swing characteristics can be made to rapidly occur and continue in both the UDD and TD swings.

Details of these steps are described in greater detail in the following paragraphs.

### 3.2.2 Upwardly Disrupting Discovery (UDD) Processes

The upwardly disrupting parameters which have been found to be most effective are those related to small or minority constituents of energy internally generated in the downswing. “Small or minority” should be interpreted as meaning not more than about one third of energy generated or one third of positive energy generated in the downswing because about one third is believed to be the maximum which can be attained by the left hip or right hip in a swing without promoting an excessive unbalance in joint energies. Because no method has yet been discovered to subdivide hip joint energy generation, the “small or minority” general definition is set at about one third. Energies generated across individual joints in the downswing, have been found to be particularly effective as upwardly disrupting parameters.

Some other characteristics of PEDs have also been found to be occasionally effective. One such characteristic comprises a measure of onset or commencement of PED in the downswing, which will be referred to as “PED-onset”. Measures of PED-onset include, for example, the projected angle of the club shaft in the coronal plane in the downswing at which the PED-onset occurs. Where possible, it will usually be found advantageous to frame the measure such that an earlier PED-onset gives rise to an increase in the measure and vice versa. This will align the changes with changes in energy values in feedback, where increases typically signal improvements and vice versa. All such upwardly disrupting parameters have the characteristics of being related only to a minority or small part of total PED and being associated with general increases in total PED.

Because of the tendency of PEDs and their associated upwardly disrupting parameters to frequently commence or end in a relatively unclear or unpredictable manner, it is often found better to view the starts and finishes of these parameters as occurring between the start and finish of the main portions of the positive energy, and in the example, starting when about 15% of the positive energy has been generated and ending when about 85% of the positive energy has been generated. The torque is usually evaluated as the average torque across the untrimmed central portion of energy generation. In the example it is taken between 15% and 85% of the positive energy generated. Parameters with their starts and ends trimmed in this way, may be referred to as “trimmed” parameters. Trimmed values are of particular relevance for PED-onsets or where an average torque value is taken over the course of the downswing.

Upwardly disrupting parameters have been found to be very effective in causing the player's subconscious self-organising-system to experiment with new swing movement patterns. In addition, they have the advantageous potential to drive general PED energy levels upwards. It is believed that these two characteristics are strongly related. Swing movement patterns comprise numerous interconnected components. Where the subconscious self-organising-system is not upwardly disrupted, this interconnectedness is believed to largely responsible for the typical vehement resistance of the subconscious self-organising-system to making any significance changes to a single joint energy, because changing one will involve changing an entire pattern of different joint energies. However, where the subconscious self-organising-system is positively upwardly disrupted, as occurs in the method of the invention, its resistance to change is typically overcome and while trying to raise the upwardly disrupting parameter it raises or “leverages” all or many of the numerous interconnected components, thus raising multiple individual PED values and, where the principles of the present invention are followed, overall total PED value.

UDD also provides further benefits in addition to its ability to stimulate the subconscious self-organising-system to explore and experiment with other swing movement patterns. One additional benefit is that it can improve the player's conscious and unconscious awareness of, and ability to, potentially increase joint energies in later swings in the same joints as used in the upwardly disrupting parameters. Another additional benefit is that it can cause the player's subconscious self-organising-system to store or memorise subconscious movement patterns, or parts of subconscious movement patterns, associated with increases in the particular upwardly disrupting parameter, any of which may be later used to improve the swing. A further benefit is that increases in energy-related parameters of other joints, which changed to accommodate increases in the upwardly disrupted parameter, may also be used later by the subconscious self-organising system to improve the swing.

### 3.2.2.1 UDD Parameter Selection in a Session.

In the example, the system arranges alternating sets of UDD and TD swings. Over each session, different upwardly disrupting parameters, associated with different joints, are selected by the system from the typical joint candidates, or “combinations” of typical joint candidates, shown in FIG. 5.

Upwardly disrupting parameters associated with the following joints can usually be used successfully in all sessions: left hip; right hip; lumbar; thorax; left knee or left knee and left ankle; right shoulder or right shoulder and right-shoulder-girdle; and right elbow. Left hip and right hip, because of their relatively large energy magnitude and overall importance, are usually selected at about twice the frequency of the other selected joints listed above. Other candidate joints may also be selected on an occasional basis.

Sets of UDD swings are repeated many times, interspersed by sets of TD swings, but with the emphasis in each UDD set on a particular upwardly disrupting parameter. The particular joint, associated with the upwardly disrupting parameter, is changed to a different joint after each UDD set. For example, in a session, the upwardly disrupting parameters may comprise increases in the PED magnitude values of the joints mentioned for favoured selection in the previous paragraph, and where time permits, repeated over the duration of the session.

In addition to selecting the joint, the system also selects the type of energy generation parameter which is used, the choice typically comprising the PED magnitude, PED-AD, PED-AT or PED-onset associated with the joint. PED magnitude is usually selected unless there is a particular reason for the system to choose one of the others.

An important consideration in selecting joints is that swings are more advantageously improved by concentrating on UDD improvements in some joints over others. Besides favouring joints which are typically associated with greater energy generating potential, the right knee, right ankle, wrists, grip, left shoulder and left elbow should be used sparingly, if at all, in UDD processes. To optimise the UDD process, downswing joint energy should be promoted significantly less in the right knee and right ankle than in the left knee and left ankle, respectively, because of known optimum functioning patterns of the left and right legs in the downswing. The UDD process should also be promoted significantly less in the left shoulder and left elbow, than in the right shoulder and right elbow, to advantageously promote power generation on the right side and promote control on the left side of the upper body and arms. Although potentially important in power generation, caution is advised with respect to promoting power at the wrists and grip, to ensure that optimum conditions for correct wrist lag and release are not frustrated. The optimum action at the wrists is best promoted by a separate intervention process described later in the specification.

### 3.2.2.2 UDD Instructions.

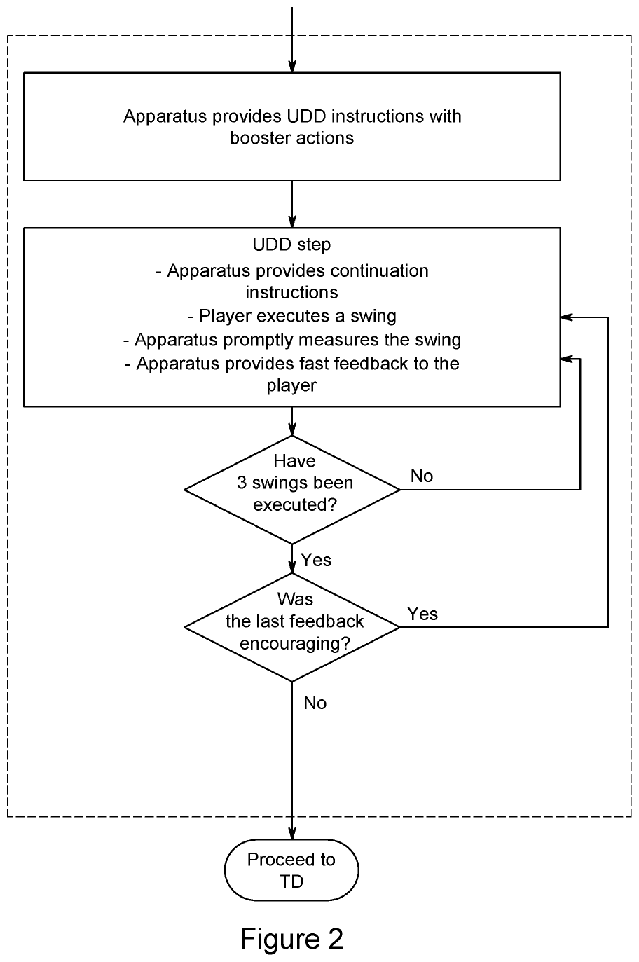

Reference is now made to FIG. 2, which shows the principal steps involved in executing a set of UDD swings. The set commences with the step of UDD Instructions which is given before each UDD set of swings. The instructions usually comprise audio communication and minimal visual communication. However, in certain circumstances it may include more substantial visual communications, for example, pre-prepared visual demonstrations or diagrams. Where possible, instruction is kept simple and brief, usually not exceeding one minute. Where the system has noted that the player has previously failed to execute the instructed directions in a competent manner, more substantial visual communication may be given.

The instructions typically comprise identification of the upwardly disrupting parameter and brief details of required actions or modifications to actions, henceforth referred to as “booster actions”, which are designed to boost or increase the selected upwardly disrupting parameter to an increased or exaggerated higher level. Although the greatest emphasis is usually placed on the downswing, considered attention is also given to the address, backswing and early follow-through.

As mentioned elsewhere in this document, although the overt instructed objective is to increase the selected upwardly disrupting parameter, the most important objective is to upwardly disrupt or stimulate the subconscious self-organising-system to break away from its current arrangement of movement patterns and form new movement patterns with an average upward pressure across the wider range of positive energy generation parameters.

### 3.2.2.3 UDD Booster Actions.

UDD parameter booster actions typically comprise exaggerated or highly emphasised forceful displacements, speeds and velocities in the downswing and through impact and into the follow-through, abbreviated to “into FT” below. The player is encouraged to treat the individual selected UDD parameter as the leading dominant parameter to be intensively focused on in a highly energetic, furious and aggressive downswing. The tone of verbal instruction on action in the downswing and very early follow-through should encourage highly vigorous and powerful action. Booster actions also typically comprise sets of exaggerated or highly emphasised displacements and positions in the backswing and TOB (top-of-backswing). Booster action instructions are kept simple and partly repetitive from set-to-set.

Examples of some of the elements of booster action movements at key UDD joints are shown below. For sake of brevity, the examples omit all exaggerated and vigorous wording.

Right hip backswing: Right hip pull-rotates the pelvis winding clockwise, tilted.

Right hip downswing and into FT: Right hip pushes weight shift back to the left foot; right hip push-rotates the pelvis, unwinding counter-clockwise, tilted, forward to and through impact.

Left hip backswing: Left hip push-rotates the pelvis winding clockwise, tilted.

Left hip downswing and into FT: Left hip pulls lateral-weight-shift back to the left foot; left hip pull-rotates the pelvis, unwinding counter-clockwise, tilted, forward to and through impact; and left hip straightens the left leg to push the left foot into the ground.

Left knee backswing: Left knee assists the winding clockwise push-rotation of the pelvis.

Left knee downswing: Left knee pulls lateral-weight-shift back to the left foot: left knee pull-rotates the pelvis forward unwinding counter-clockwise, tilted; and left knee straightens the left leg to push the left foot into the ground.

Lumbar backswing and TOB: Lumbar lowers the right side down, with right hip moving away and back, into a squat or ready-to-pounce position by TOB.

Lumbar downswing and into FT: Lumbar thrusts downward and forward at the commencement of downswing and rises up coming into impact.

Thorax backswing and TOB: Thorax rotates right shoulder far around, creating a steep shoulder tilt down towards the ball by TOB.

Thorax downswing and into FT: Thorax rotates, pulling the right shoulder down and forwards towards the target.

Right shoulder backswing and TOB: Right shoulder pull-rotates the shoulder line around and to a steep tilt by TOB.

Right shoulder downswing and into FT: Right shoulder push-rotates down and forward towards the target, overall getting lower to the ground, with the right shoulder then continuing towards the target.

Right elbow backswing and TOB: Keeping the left arm straight, right elbow moves such that by TOB, its angle exceeds a right-angle and the right upper arm is pointing towards the ground.

Right elbow downswing and into FT: Right elbow keeps close to the body as the downswing progresses, first down and then rotating through to impact, avoiding the right arm straightening out and maintaining daylight between the arms.

### 3.2.2.4 UDD Execution and Feedback.

When the step of UDD instruction is completed, the player proceeds to a step which includes UDD swing execution and feedback. Reference is again made to FIG. 2, which shows the principal sub-steps involved in the UDD step. The set commences with the sub-step of continuation instructions, followed by the sub-step of the player executing a swing, further followed by the sub-step of the player receiving feedback on the swing.

In the first swing of the set, the continuation instruction instructs the player to execute a swing following the more detailed “UDD instructions” of the previous step, and in subsequent swings it instructs the player to execute a further swing of the same type.

Following each swing the player is given near-instantaneous feedback indicating the degree to which he has achieved or failed to achieve the particular instructions. It is commenced as quickly as possible, and always within one to five seconds of the completion of the swing. In total, it should be completed within about five to ten seconds to minimise time lost between swings. UDD feedback comprises audio and visual feedback with audio communication playing the primary role.

Except where a particular record has been exceeded, feedback is usually based on a comparison between the current swing and the previous swing in the session, or in the case of the first swing, a comparison between the current swing and the average of grounding swings which are discussed later. Such audio feedback typically comprises a brief spoken message indicating the qualitative degree of improvement or otherwise. Where a particular record has been exceeded in a predetermined manner, audio feedback for very positive or encouraging results typically comprises a period of very enthusiastic crowd cheering. Audio feedback for moderately positive or encouraging results typically comprises a period of crowd applause. This type of feedback may last for about five seconds, but prematurely ended if the player commences a further swing. Visual communication typically includes numerical displays of the latest value, the previous value, and the current high-record value. Audio feedback with graduated crowd applause and cheering, depending on the quality of feedback, has been found to provide very effective positive player and subconscious self-organising-system responses. For example, it has been found effective to use applause where an existing record is matched or slightly improved, for example improved by about 5%-10% of the current record, and to use applause and enthusiastic cheering where an existing record exceeds that amount.

### 3.2.2.5 Continuation Criteria and Further Directions.

When feedback for an individual swing is completed, the player is directed to the next step, which may be another UDD swing or a change to a TD swing. If it is another UDD swing, the player is given very brief instructions repeating the basic continuation instruction. As can be seen from FIG. 2, following the execution of three UDD swings, the UDD cycle will be repeated while feedback remains “encouraging”, but otherwise proceeds to a set of TD swings.

In the example, the term “encouraging” is interpreted as meaning that the feedback result for the magnitude value of the upwardly disrupting parameter indicated it to be similar or better than that of the previous swing, where “similar” means, for example, within +/−5% of the value. Alternative rules can be used, such as the term “encouraging” being interpreted to mean that the feedback result for the magnitude value of the upwardly disrupting parameter is greater than that of the previous swing.

This system of continuing UDD swings until encouraging feedback ends, appears to match the apparent “mood” of the subconscious self-organising-system, in that the subconscious self-organising-system continues to explore different movement patterns with a particular upwardly disrupting parameter until it apparently rejects further exploration. From detailed observation of test results across all joint energy body components, this appears to assist in gradually building up a subconscious repertoire of movement patterns or portions of movements patterns which get reassembled in later improved swings by the player. Tests of this type have also indicated that persistence with a rejected upwardly disrupting parameter has adverse effects in conducting continued UDD and TD cycles, and such persistence should be avoided.

### 3.2.3 Tempering Discovery (TD) Processes

### 3.2.3.1 Background

TD processes serve two main purposes. One of these is to encourage the subconscious self-organising-system to execute swings with an overall, that is overarching, target of increasing swing strength, accuracy and consistency, while the subconscious self-organising-system remains or lingers in exploratory mode following the set of UDD swings. The other main purpose is to prevent the subconscious self-organising-system drifting to increasing the upwardly disrupting parameters at the expense of swing strength, accuracy or consistency, which has been observed to occur where even moderately prolonged uninterrupted periods of UDD stimulation occur. In such cases, the overall “efficiency” of the swing can drop to a degree where, clubhead speeds at impact fall even though greater amounts of energy are generated. Throughout this document, the term “efficiency” should be understood to mean the ratio of the value of positively generated energy in the downswing to the value of the kinetic energy of the clubhead just prior to impact with the ball.

If TD were conducted in the absence of UDD, it would differ little from practicing on a driving range with equipment which gave feedback on distance, clubhead speed or ball speed. As is well known, such practice does not noticeably upwardly disrupt or stimulate the subconscious self-organising-system or cause much variation in subconscious movement patterns. With prolonged driving range practice over an extended period of weeks or months, some improvement may occur, but even then, only at a relatively slow rate and often reaching limits if not supplemented with regular play or significant levels of conventional coaching.

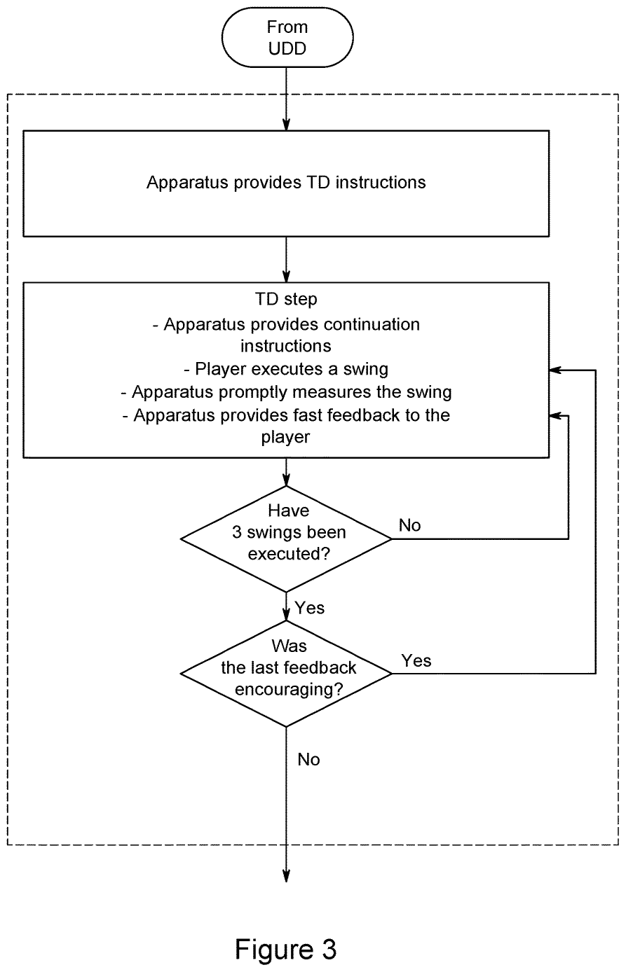

Reference is now made to FIG. 3, which shows the principal steps involved in TD processes. Similar to UDD processes, the set commences with the sub-step of providing TD instructions. This is followed by the TD step which commences with the sub-step of continuation instructions, followed by the sub-step of the player executing a swing, further followed by the sub-step of the player receiving feedback on the swing. The system uses audio and visual communication to deliver the very brief instructions and to instruct the player to execute the swing.

### 3.2.3.2 TD Instructions.

In the TD instruction step, the player is given instructions to execute normal type swings, typically requesting the player to increase or maximise one of the improvement-parameters, for example to drive the ball as far and straight as possible. TD instruction is typically much briefer than UDD instruction.

### 3.2.3.3 TD Execution and Feedback.

Following each TD swing, the player is given near-instantaneous feedback indicating the degree to which he has achieved or failed to achieve the instructions. More often than not the calculations will be based on increasing clubhead speed and kinetic energy at impact, even though the wording of the TD instruction may be based on hitting the ball as far and as accurately as possible. (Throughout this specification, clubhead speed or kinetic energy at impact should be understood to mean clubhead speed or kinetic energy, respectively, immediately prior to impact, at the instant before the impact event causes the clubhead to slow down).

In the present example, TD feedback can be optionally selected by the user to be determined either by changes related to clubhead kinetic energy at impact or by changes related to estimated ball distance. The advantages and disadvantages of these alternatives are discussed later in the specification. Audio and visual feedback are provided in a similar manner to that in UDD, but with feedback communicating performance relative to the TD parameter.

As can be seen from FIG. 3, following the execution of three TD swings, the TD cycle is repeated while feedback remains “encouraging”, but otherwise proceeds either to further UDD swings with a changed upwardly disrupting parameter, or to termination of the UDD-TD cycle. In the example, similar to that for UDD swings, the term “encouraging” is interpreted as meaning that the feedback result for the magnitude value of swing improvement indicated it to be similar or better than that of the previous swing, where “similar” means, for example, within +/−5% of the value. Alternative rules can be used, such as the term “encouraging” being interpreted to mean that the feedback result for the magnitude value of swing improvement is greater than that of the previous swing.

### 3.2.4 Intermingling UDD and TD Swing Sets.

Intermingling UDD and TD swing sets has proved to be very effective in upwardly disrupting and stimulating the subconscious self-organising-system and producing overall improvement in subconscious movement patterns, with the improvements occurring both in the UDD and TD swings. Important reasons why intermingling benefits both UDD and TD swings appear to be that the subconscious self-organising-system upward disruption caused by the UDD swings is temporarily carried over or lingers into the following TD swings, overcoming the usual resistance of the subconscious self-organising-system to explore and change its ingrained subconscious movement patterns. Furthermore, the focused directionality of the TD swings is temporarily carried over or lingers into the following UDD swings “encouraging” the subconscious self-organising-system to take on more tempered or directed improvements, both in energy generated parameters and in the efficiency of energy transmission to the clubhead.

Repeated cycles of small sets of UDD swings followed by small sets of TD swings have been found to work most effectively. The numbers of swings in these sets are found to involve a compromise between competing factors. Smaller numbers of swings per set have the following relative advantages. First, the cycle times between sets of UDD and TD swings becomes smaller, with benefits to both as already explained, including keeping the TD swings upwardly disrupted and stimulated and keeping the UDD swings directed towards stronger and more accurate swing outcomes. Second, the subconscious self-organising-system behaves in a manner that appears to favour initial probing experimentation, such that its best results often occur in the first few swings following a change in upwardly disrupting or tempering instructions. Thus, the quality of results tends to wane with increasing numbers of swings in a set where the upwardly disrupting parameter or tempering parameter remains unchanged. On the other hand, larger numbers of swings per set have the following relative advantages. First, as the instructions step usually only needs to be given at the start of each set, larger numbers of swings in a set require smaller proportions of instruction time. Second, an important element of the system is the ability to act on feedback from the previous swing which followed the same instruction. Since the first swing of a set does not have this feedback advantage, larger numbers of swings in a set increases the proportion of swings which follow the near-instantaneous feedback.

It has also been found that approximately equal numbers of UDD and TD swings per set work well, and that individual set numbers of three also worked very successfully provided the number is increased where positive or encouraging feedback has been obtained on the final swing of a set.

Tests, where body components are joints, have indicated that, where UDD and TD sets are intermingled over a session in the manner described above, more often than not, the highest individual joint value will occur in UDD swings where that individual joint is not the same joint as the UDD parameter joint, or in a TD swing where that individual joint is not the same joint as used as the UDD parameter joint in the preceding UDD swings. This indicates the strong connectiveness of the joint parameters when the UDD process leverages up the interconnected joints involved in the subconscious movement patterns.

### 3.2.5 Intrinsic Requirement for Automatic Operation.

Successful or optimal operation of the UDD and TD processes requires a full or high degree of automation. The steps are not just implemented in this manner to facilitate convenience, but also because the required steps in the method must be implemented automatically by the apparatus to operate in the most effective manner. Reasons for this include the following. First, repeated sets of UDD and TD swings need to be organised and executed at a fast rate to achieve successful intermingling and lingering of the benefits of each type across to the other. Second, measurements and calculations needed for UDD feedback demand high-speed measurement, processing and communication, all of which require the special apparatus of the invention. Third, relatively complicated progress records need to be constantly updated and maintained, to provide the basis for feedback across numerous UDD and TD parameters. These various tasks could not be performed manually within the time constraints of the UDD and TD processes.

In addition to requiring a high degree of automation, the UDD and TD processes are particularly well suited to automation because discovery learning utilises the skills and potential of the player's subconscious without need for external coaching analysis.

### 3.2.6 Other Conditions which Assist UDD

Other conditions favourable to UDD include reducing player anxiety in executing swings, reducing anxiety in changing existing subconscious movement patterns, and eliminating circumstances which distract from the execution of UDD instructions. Such anxiety or distraction is of particular significance for beginners or unaccomplished players, where correctly striking the ball with a driver or long iron club is frequently difficult and daunting, especially where the player is being observed by others. It is a further insight of the invention that such anxiety and distraction can be reduced or eliminated in the learning process if the ball is replaced by a virtual-ball-target which will not unduly upset the learning process if the ball is struck incorrectly or missed. Henceforth, a practice mode or swing using a virtual-ball-target instead of a ball shall be referred to as a “without-ball” swing or practice mode and one with a ball shall be referred to as a “with-ball” swing or practice mode.

Replacing the ball with a virtual-ball-target of this type also assists UDD and TD in other ways, both for inexperienced and experienced players. One is that it will typically speed up the rate at which UDD and TD swings are executed, partly because it is not necessary to retrieve and tee up or position a ball and partly because it eliminates time consumed observing ball flight and landing. Another is that it minimises or eliminates confusion for the player's conscious and subconscious interpretation of UDD feedback, which is deliberately primarily concerned with performance related to the upwardly disrupting parameter and not with the accuracy with which the ball is struck. This increases the effectiveness of UDD feedback. Replacing the ball with a virtual-ball-target can also permit use of the apparatus where an open range or capture net or screen is not available, or in confined areas where it is considered dangerous to use a ball.

The apparatus is arranged such that UDD and TD can be optionally carried out either with a virtual-ball-target or with a ball. The virtual-ball-target typically comprises a flexible white rubber tubular moulded structure, extending into the space where the ball and tee otherwise reside. An advantageous audible sound is naturally made when the club strikes the virtual-ball-target.

As previously mentioned, TD feedback communicated to the player can be optionally determined by changes related to clubhead kinetic energy at impact or by changes related to estimated ball distance. These alternatives can be used both for without-ball and with-ball modes.

Where TD feedback is related to clubhead speed or energy at impact, it has been found useful to express the values in terms of clubhead kinetic energy, because these parameters share the same units as energy generation parameters, and where swing efficiency can be readily expressed and understood as a ratio related to these two values. Where TD is related to ball carry or distance travelled, in without-ball mode, the values are estimated by using the measuring system to assess how accurately the clubhead contacts the theoretical ball position at impact, and combining this information with the measured speed of the clubhead at impact. Where ball speed is measured by the measuring system, this information can be additionally used to estimate to estimate ball distance or carry.

For less accomplished players, it is usually found better to base TD feedback on data related to clubhead speed for all or at least a significant proportion of swings because it removes anxiety and distraction, as previously discussed.

### 3.2.7 Other Session Activities

### 3.2.7.1 Overview.

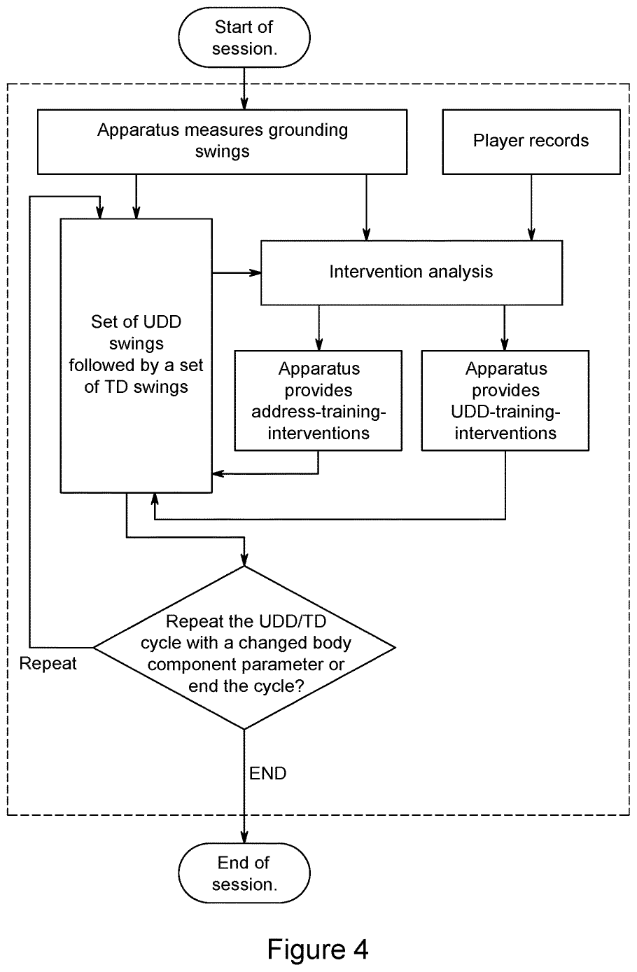

Reference is now made to FIG. 4 which shows a flow chart which, for sake of clarity in the figure, depicts the intermingled sets of UDD and TD swings sets in a single combined step. The combined step comprises the steps show in FIGS. 2 and 3. FIG. 4 also shows various supporting steps in the example session.

Referring now to FIG. 4, the session commences with the supporting step titled “grounding swings”. This is followed by the fundamental step, or set of steps, titled “Set of UDD swings followed by a set of TD swings”. As indicated in the chart, the cycle may be continually repeated or the session ended, as required. The figure also shows the optional steps of “UDD-Training-Interventions” and “Address-Training-Interventions”.

The supporting steps are described in greater detail below. All principal activities, other than swing execution by the player, are carried out automatically in the example to allow players successfully operate the system without external assistance.

### 3.2.7.2 Grounding Swings.

A session is typically commenced with a set of grounding swings. The average values of the grounding swings are used both to update the player's swing record and to serve as an initial basis for feedback comparisons in later UDD and TD swings in the session. Typically, the set of grounding swings will comprise about ten natural swings, without learning instruction, with the same club used throughout the session. Where the club is a distance club, the system typically instructs the player to execute the swings as normal distance shots, driving the ball straight and far. Mishit shots are automatically excluded when calculating average values of grounding swings.

Grounding swings are also used to automatically track, identify and analyse swing errors for possible use in UDD-training-interventions and address-training-interventions, which are described below.

### 3.2.7.3 Address-Training-Interventions and First-time Address Instructions.

Correct address is deemed to be of high importance in swing improvement. Its static aspect causes it to uniquely fall within the player's conscious control. It also differs from other portions of the swing in that its optimum execution comprises a significant number of elements which do not appear to be intuitively obvious either to the player's conscious or subconscious control and are therefore better improved more by techniques with coaching aspects than by discovery learning processes alone. Correct address procedures are well established in prior art and will not be discussed in this document.

In the home-use example method, when a player uses the system for the first time or uses a particular type of club for the first time, the system will instruct him in how to adopt the correct address stance. Thereafter, general instruction on the correct address stance will only be given when requested by the player through the system user interface, and corrections to the address stance will instead be given by address training interventions, as described below.

Where the apparatus comprises a pose estimation (PE) system, care is taken to ensure that camera views and playing mat markings are arranged such that all common address errors can be identified by the PE system. Depending on the complexity of the required address training intervention, the intervention can be made either by the same apparatus system used in UDD processes to provide instruction, measurement and feedback, or for simpler interventions, by an addition of appropriate wording to subsequent UDD instructions. To distinguish these address-related processes from the discovery learning processes discussed earlier, they shall henceforth be referred to as “address-training-interventions”. Although closer to a coaching process than a discovery process, the address-training-process still benefits from its temporal proximity to the intermingled UDD and TD swings which cause the player to be more open to accept and adopt improvement changes to the swing than would be the case in a conventional coaching lesson. For this reason, the process is referred to by the broader term of “training” process.

FIG. 4 indicates the general approach to controlling and interjecting these interventions. Data is obtained from the player's past and current records, current grounding swings and current UDD and TD swings. The data is analysed across a well-established range of address parameters and, where significant detected errors occur, the system selects the most appropriate errors to be corrected or improvements to be made, in addition to the most appropriate times to interject them before or during current intermingled UDD and TD swings. Address-training-interventions are most commonly given before UDD swings commence; the errors having been detected during grounding swings.

### 3.2.7.4 UDD-Training-Interventions and First-Time Swing Instructions

The example apparatus also tracks and analyses the kinematics of swings executed by the player and maintains player kinematic swing records which are regularly updated. This is described in greater detail later in the specification. Inter alia, these analysed kinematic data are used to provide training interventions related to UDD processes, as described earlier, and what will henceforth be termed “UDD-training-interventions”.

UDD-training-interventions have a coaching aspect which is largely of an empirically established nature, and often of a character that is not intuitive either to the player's conscious or subconscious understanding, and therefore unlikely to be explored and discovered by natural discovery learning without very specific guidance. The interventions also have a UDD aspect in that they are interjected during intermingled UDD and TD sessions while the player's subconscious self-organising-system remains positively upwardly disrupted and more open to changing ingrained habits and subconscious movement patterns. Usually, the interjection is made just before or during a UDD set of swings in the session.

In the home-use example method, when a player uses the system for the first time, the system will instruct him in how to correctly execute the basic movements of the swing, including correct takeaway, backswing weight shift, downswing weight shift and hitting through the ball at impact. Thereafter, general instruction on the correct address stance will only be given when requested by the player through the system user-interface, and corrections to swing movements will instead be given by UDD-training-interventions, as described below.

FIG. 4 also indicates the general approach to controlling and interjecting these mixed discovery learning and training interventions. The approach is very similar to that described above for address-training-interventions and will not be repeated.

The parameters, subject to intervention analysis and UDD-training-interventions, fall into several categories. One category involves errors detected in the player's swing, another category presents opportunities to adopt techniques which will improve the swing and yet another category involves techniques which teaches techniques which modify the swing for particular non-standard situations.

The first category typically includes errors in: takeaway; lateral weight shift in the backswing; lateral weight shift in the downswing; foot or heel lifting, knee flexing, body tilting and left arm straightness in the backswing and downswing; grip errors occurring during the swing; squareness of clubhead trajectory and club face coming into impact; and hitting through impact into the follow-through. Common slicing and hooking errors are usually the result of errors already listed in this paragraph. The second category typically includes: wrist lag and release; hips commencing the downswing prior to the club completing the backswing; and increases in X-factor and X-factor stretch. Further details on these parameters are beyond the scope of this specification. The tracked model provides the necessary data required for the interventions. The third category typically includes techniques such as creating deliberate fades or draws in the swing.

Two examples of these mixed discovery learning and training interjections shall now be discussed, illustrating a very brief simple interjection and a more substantial interjection. A common error which occurs with less accomplished players is incorrect lifting or over lifting of the left heel in the backswing, which negates much of the benefits of the rotational wind-up in the backswing. A fault of this type is readily detected by the system and is eliminated by temporarily adding very brief appropriate wording to each UDD instruction, warning the player to cease the error, until the player corrects the error. An example of a more substantial interjection is given by the system instructing a more advanced player as to how he can improve the strength of his swing by adopting correct wrist lag and release in the downswing. This will typically involve some detailed instruction and swing execution with specific feedback on relevant wrist lag and release parameters.

### 4.0 Home-Use Examples of Apparatus

Several embodiments of an example apparatus, suitable for home-use without human assistance, shall now be described.

### 4.1 First Described Embodiment

In a first embodiment, the measuring means comprises a combined 3D HPE (human pose estimation) and 3D OPE (object pose estimation) system, a speed measuring system and a kinetic parameter prediction machine-learning system. The kinetic parameter prediction system is operable to predict kinetic parameters using, inter alia, output data from the HPE and OPE measuring system and speed measuring system. The HPE and OPE systems, measure the positions and movements of the player and club, respectively. Henceforth, the combined HPE and 3D OPE systems may be referred to as the “PE” (pose estimation) system. The PE system comprises two camera sensors mounted in separate tripod-supported enclosures. The enclosures also encapsulate laser guide devices and processing units. The speed measuring system comprises a speed measuring sensor and is mounted in one of the enclosures.

The apparatus also comprises a marked playing mat, a tee or virtual-ball-target, and a portable computing means with a speaker, screen and user interface. Where required, an additional plain mat, not shown in the figure, can be used to elevate the player to the same height as the playing surface.

The portable computing means and the processing units within the enclosures may be collectively referred to as the “processing” or “computing” means or system.

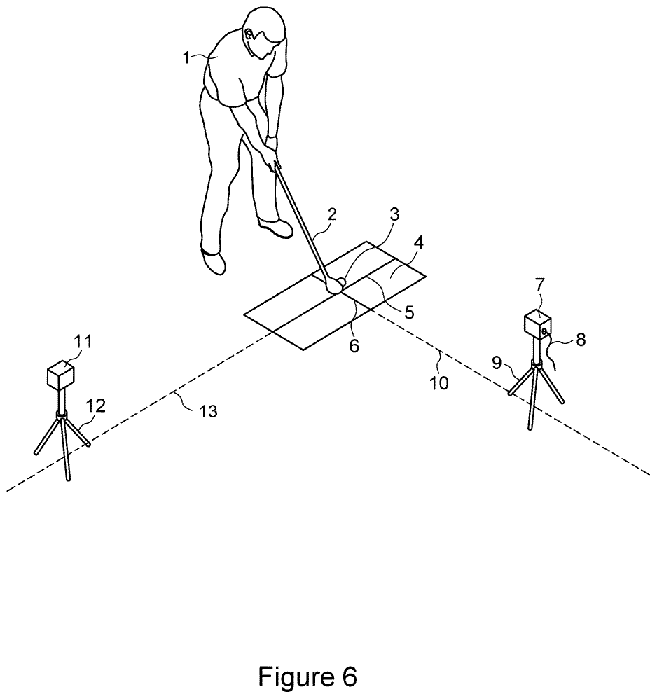

Reference is now made to FIG. 6 which shows a pictorial representation of a player and club, using the particular apparatus embodiment in with-ball mode. The following is an index of the reference numerals used in the figure.
1. Player.
2. Club.
3. Ball, supported by a tee.
4. Playing mat.
5. Target direction line marked on the playing mat.
6. Face-on direction line marked on the playing mat.
7. Enclosure encapsulating the face-on camera sensor, processor unit and laser guide.
8. Lead from enclosure to the computing device.
9. Face-on tripod support.
10. Face-on view, shown projected onto the ground.
11. Enclosure encapsulating the down-the-line camera sensor, processor unit, laser guide and speed measuring sensor.
12. Down-the-line tripod support.
13. Down-the-line view, shown projected onto the ground.

The playing mat comprises a durable artificial turf surface. The surface is permanently marked with two mutually orthogonal lines. One of these lines, referred to as the target line, is parallel to the long edges of the playing mat and indicates the theoretical direction of the hole on the green or the theoretical direction in which a correctly struck ball should travel. Although concealed by the ball in the figure, a hole is provided in the playing mat at the intersection of the two marked lines, and a tee protrudes up through the hole, supporting the ball. The cameras are arranged to ensure that they obtain images of the playing mat and permanently marked mutually orthogonal lines other than when the lines are occluded by the player or club.

The face-on camera sensor and laser guide device are aligned orthogonally with the target direction and tee, at a set distance from the tee or front edge of the mat, and a set height from the ground. These set distances are determined, inter alia, by the camera lens and the distances used when the PE system is initially trained. The laser guide is provided to simplify set up. It is momentarily activated during set up, and projects a line onto the ground and playing mat. The tripod is positioned by a user such that it is at the correct set distance from the tee or edge of the mat tee, with the projected laser line simultaneously falling on the face-on direction line, marked on the playing mat. The down-the-line camera sensor and laser guide device are similarly set up by a user, but in this instance aligned with the target direction and tee, at a set distance from the tee or short side of the mat, and a set height from the ground. The speed measurement sensor is also encapsulated in the same down-the-line enclosure and arranged such that it operates correctly when the camera within the enclosure is set at the correct distance and height.

The arrangement of camera views shown in the figure has several advantages. It potentially offers good depth measurement and little occlusion. The positions and angles are easily understood and set up by a home-use user. It provides a face-on camera view of the important address position and impact event. It provides a down-the-line direct camera view of the path of the ball above the target direction line, facilitating evaluation of the accuracy and squareness of the clubhead path through impact. It allows the speed measuring sensor to be placed in the same enclosure as one of the cameras. It avoids placement of cameras beyond the tee position, where a very badly struck ball could be inadvertently launched almost sideways from the clubhead.

The PE system is arranged to regularly check that both PE camera views are correctly positioned, within the acceptable tolerance of the orthogonal marked lines on the playing mat. The system is arranged to automatically alert the user if either of the cameras have been set up incorrectly or if relative movement occurs between the cameras and playing mat in the course of a session. The check can be used to assist in camera set up, with the system advising the user with respect to alignments and distances. The check can also be used in bright outdoor conditions where the projected laser lines may be difficult to see. The portable computer is connected by wire to the face-on enclosure and may be mounted on any convenient surface with its screen within view of the player. The down-the-line enclosure may be connected wirelessly or by wire to the rest of the processing system, including the portable computer and face-on enclosure. Connection by wire simplifies the PE software and synchronisation of devices, wireless connection simplifies user convenience.

The portable computer provides the communication system for the feedback means, including a screen which communicates visual feedback to the player; and either a speaker, not connected to the player, or earphones or headphones connected to the player, which communicates audio feedback to the player.

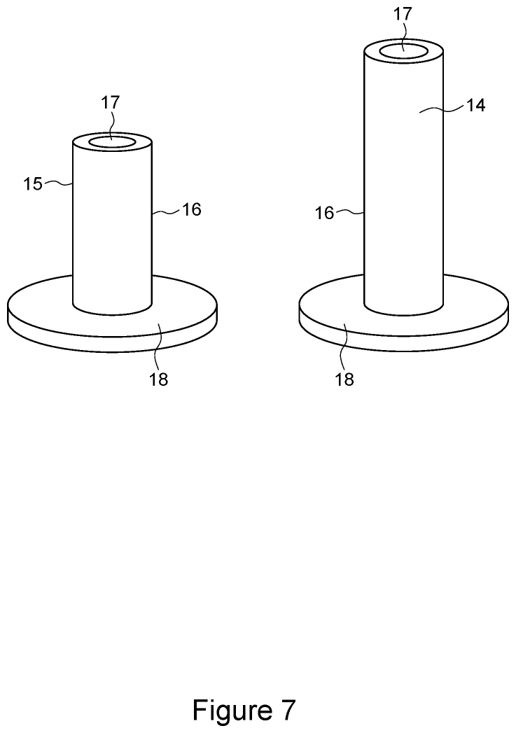

Reference is now made to FIG. 7 which shows a pictorial representation of a tee moulding and a virtual-ball-target moulding of the types used in the example embodiment. The following is an index of the reference numerals used in the figure.
14. Virtual-ball-target moulding.
15. Tee moulding.
16. Tubular body.
17. Hole on the top of the tubular body.
18. Flange at the base of the moulding.

The tee comprises a flexible rubber moulding with a hollow tubular body, open at the top, and with an outward moulded flange at its base. The tubular body fits snugly through a hole in the playing mat and the flanged base prevents it being pulled out of the hole. The virtual-ball-target also comprises a similar flexible rubber moulding but has a much taller tubular body. Such mouldings are readily obtainable in different heights as they are commonly used at driving ranges. Tees and virtual-ball-targets of different heights can be easily interchanged or replaced.

### 4.1.1 Further Details of the Apparatus

### 4.1.1.1 the PE System.

The pose estimation (PE) system comprises a combination of an HPE and OPE system which is operable to estimate the positions and movements of the player and club, respectively, using a machine learning system and two cameras which are operable to capture images at different camera view angles. The cameras ideally run at 100 frames per second or greater, producing unblurred images. Lower frame rates can be used, but accuracy is improved by higher rates. The PE system identifies key points on the player's body model and club and estimates their 3D kinematic motion through the swing. The body model is the same or similar to that shown in FIG. 5, comprising rigid segments connected by joints. The PE system uses advanced HPE and OPE techniques which are well established in prior art. The machine learning system is trained with a “ground-truth” high-accuracy 3D motion capture system to provide training inputs against which predictions can be compared and trained. Emphasis is placed on sequence-based methods, taking maximum advantage of the typical swing following an approximate smooth rotational path through the backswing, which is then reversed through the downswing and follow-through. The term “end-use” will be used to refer to use of the completed trained PE system by a player or user.

A selection from the following additional techniques is used in the PE system.
The machine learning system is trained with golf swing movement sequences including the club, rather than general movement sequences available from general HPE databases, because general movements do not include high-speed elements and pronounced effects of segment inertial forces and club centripetal forces.
The machine learning system is trained exclusively, or close to exclusively, with the movement types which occur with the training methods of the invention, including the full range of booster actions for all body components used in UDD swings, as well as swing types which occur with TD and grounding swings.
The machine learning system is also trained with information indicating the type of swing used, the body component, the energy parameter, and information on the player's status with respect to the type of swing, such as how often he has used it previously, where the swing stands in the sequenced sets of UDD and TD swings. (For example, the information might comprise: a UDD swing involving joint energy in the left hip; the second swing in a UDD set; following four previous swings of that type in the current session; and experienced 17 times previously by the player in previous sessions.)
Additional information is obtained by the independent clubhead speed measuring and impact measuring system, partly indicating the player's overall swing strength, and blended appropriately into the PE data.
The same set-up parameters for the playing mat and markings, camera lenses, camera heights above the ground and camera distances relative to the playing mat permanent markings, are used in the preparation of the training set and all swings carried out in end-use by the system, eliminating variables related to camera views, impact position and mat marker lines.
To optimise identification of 3D joint centres, the PE system analyses synchronised pairs of images from the two cameras, rather than relying on triangulation from two separate sets of 2D information from the two cameras.
The machine learning system may include convolutional neural networks and deep learning techniques.

The PE system predicts the following end-use outputs:
Streams of synchronised 3D geometric angular displacement data for all measured joints through the swing. The geometric angular displacement data is marked at a known recorded temporal frequency, so also comprises corresponding velocity and acceleration data. The data can be represented in highly compressed format by means such as wavelets or Fourier coefficients.
Identification of the temporal events of takeaway and top-of-backswing.
3D stationary images of key time points, including address, top-of-backswing and reconstruction of impact.
Relevant information on the player model, including segment lengths and joint centres.
Relevant information on the player 3D segment shapes, used to estimate data related to body segment inertial parameters.
Relevant information on club length and clubhead type and segment mass distribution, from which club category and inertial parameters can be estimated.
Images from the down-the-line camera of the clubhead path and playing mat markings as the clubhead approaches impact and progresses into the follow-through.

### 4.1.1.2 3D Model Tracking System.

A 3D model tracking system constructs the 3D motion of the player and club from address to the end of the follow-through using the kinematic outputs from the PE system and clubhead speed and impact measuring system. This kinematic representation of the entire model and club provides information which is not directly available from the PE system outputs, including data for UDD-training-interventions and feedback, which require, inter alia, translation movements of body segments. It also provides synchronised streams of 3D velocities of individual segments through the downswing and into the follow-through, from which corresponding synchronised streams of segment kinetic energies can be determined, using the predicted body segment inertial parameters, also predicted by the PE. These streams of segment kinetic energies, assist the operation of the kinetic parameter prediction system. The 3D model tracking system is also used to provide user 3D model and club animation records, some of which may be used in instruction.

### 4.1.1.3 Kinetic Parameter Prediction System.

The kinetic parameter prediction machine learning system may include some of the following features.

It predicts downswing kinetic data on the swing from data which includes kinematic data and segment mass data measured by the machine learning system. It also utilises data on clubhead speed and impact measured by the speed measuring means and impact measuring means. It places particular emphasis on sequence patterns. It comprises a high-level machine learning system which typically uses convolutional neural networks and deep learning techniques, with particular emphasis on sequence patterns.

End-use inputs to the system include end-use synchronised outputs of the PE system, and information from the speed measurement system. End-use outputs from the system comprise the synchronised individual positive joint powers through the downswing. These outputs provide sufficient information to readily calculate the cumulative individual positive joint energies at the end of the downswing and the efficiency of the swing. As mentioned previously, this is defined as the ratio of the sum of positive joint energies in the downswing, divided by the clubhead kinetic energy at impact. The machine learning system is operable to predict the following end-use outputs; synchronised individual positive joint powers through the downswing; cumulative individual positive joint energies at the end of the downswing; and the efficiency of the swing.

A selection from the following additional techniques is used in the kinetic parameter prediction system, some resembling those used in the PE system:
The machine learning system is trained exclusively, or close to exclusively, with movement types which occur with the training methods of the invention, including the full range of booster actions for all body components used in UDD swings, as well as swing types which occur with TD and grounding swings.
The machine learning system is also trained with information indicating the type of swing used, the body component, the energy parameter, and information on the player's status with respect to the type of swing, how often he has used it previously, where the swing stands in the sequenced sets of UDD and TD swings.
The machine learning system is trained with corresponding kinetic parameters and kinematic parameters, with the kinetic parameters providing ground-truth training inputs against which predictions can be compared and trained. Kinetic parameters are obtained, for example, by using motion capture data, force plate data, measurement of body segment inertial parameters and inverse dynamics calculations.
   Additional information is obtained by the independent clubhead speed and impact measuring system and blended into the PE system.
   The machine learning system is trained on data from a large number of swings from a wide and representative range of players, where the training data includes both kinematic and kinetic data.

### 4.1.1.4 Preparation of Training Databases.

To reduce costs and enhance compatibility between system variations, data for the PE and Kinetic Prediction databases, used to train the machine learning systems, are collected simultaneously, with multiple PE camera views collected at the same time. In addition to enhancing compatibility, it will provide flexibility where a product range may have different product variations with different camera view arrangements. For example, home-use products may use different camera views, as depicted in FIGS. 6, 9 and 10. In commercial applications, where cameras are used in fixed positions and camera unit cost are less important, multiple cameras may be required for multiple different views at different heights and distances from the tee. Where possible, the same arrangement of playing mat markings is used.

### 4.1.1.5 Clubhead Speed Measurement.

Where measurement is obtained in a down-the-line direction, packaged speed measurement sensors with emitters and receivers are used. Radar speed sensors are widely used for measurement of this type and are available at low cost. Where with-ball measurement is carried out, ball speed may be additionally measured by the sensor because, following impact, the ball will become the fastest moving item in the range of the sensor. Although currently more expensive than equivalent radar sensors, lidar sensors may also be used.

Where measurement is obtained in a face-on direction, clubhead speed and ball speed may be measured using a high-speed optical camera directed at the tee position. The camera may require a momentary bright or flash illumination to obtain clear high-speed images. The illumination may be triggered by detection of the clubhead entering the range of the high-speed camera or may be triggered by a separate emitter and receiver sensor. Where with-ball measurement is carried out, ball speed may be additionally measured by the high-speed optical camera by capturing at least two frames showing ball flight.

### 4.1.1.6 Processing the Measured Data.

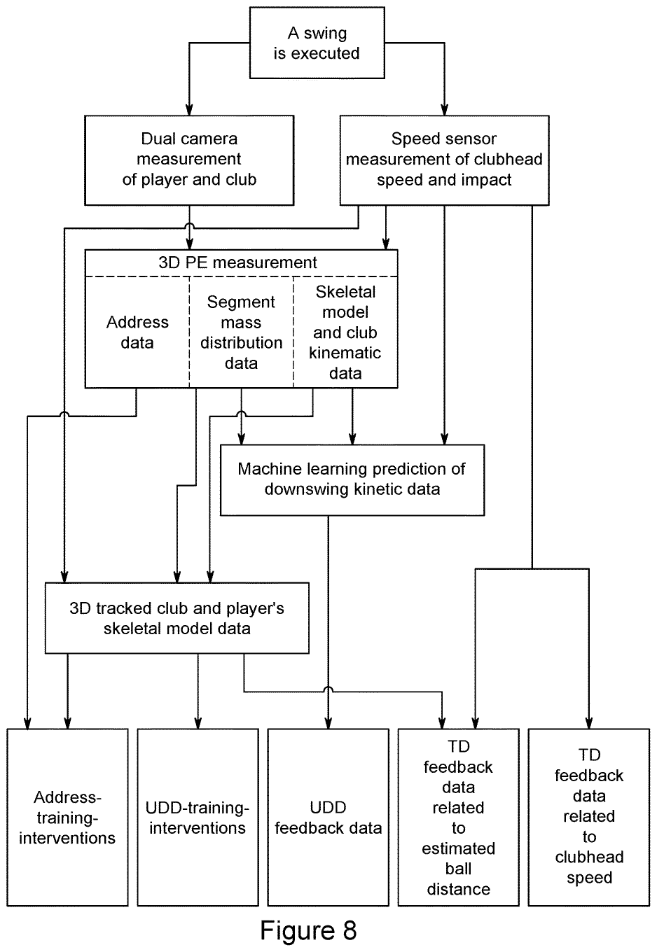

Reference is now made to FIG. 8 which shows a flow diagram summarising the processing of data by the two measuring means and the processing means. Also, as previously mentioned, the term “measure” and its derivatives should be understood to mean “measure”, “calculate”, “estimate” or otherwise “determine” throughout the specification. The diagram commences with execution of a swing and measurement of player and club positions through the swing by the camera sensors and measurement by the clubhead speed and impact by the speed measuring sensor.

The PE means, obtains measured sequenced positional data from the dual camera sensor images and measured impact time and clubhead speed data from the speed measuring sensor.

From these data it estimates the following sets of data using machine learning software. It extracts a skeletal model of segments and joints of the player and also determines the type of club used. It estimates the 3D positions of the player model and club through the swing. It estimates the approximate mass distribution of the player's segments from estimates of segment shapes. It checks the player's static position at address and identifies errors by comparison to established norms.

A separate machine learning system predicts relevant downswing kinetic data on the swing from the kinematic and segment mass distribution data measured by the PE system and data on clubhead speed and impact measured by the speed measuring sensor. The machine learning system is trained on data from a large number of swings from a wide and representative range of players, where the training data includes both kinematic and kinetic data.

The processor software also tracks the 3D kinematics of the club and player's skeletal model from data from the speed sensor and the PE means. It provides additional useful streams of segment positions, velocities and accelerations, both angular and translational, through the backswing, downswing and follow-through. It is used to assist various aspects of UDD-Training-Interventions and provide information on the accuracy at which the clubhead strikes the ball or virtual-ball-target.

Feedback for UDD feedback is obtained from the output from the machine learning kinetic prediction means. Feedback for TD feedback, related to clubhead speed just prior to impact, is obtained from the output from the speed measuring means. Feedback for TD feedback, related to ball distance, is obtained from the outputs from the speed measuring means and the 3D model and club or ball tracking means. Instructions and feedback for UDD-training-interventions are obtained from the 3D tracked club and player's model data. Instructions and feedback for address-training-interventions are obtained from the 3D PE measurement address data.

### 4.2 Second Described Embodiment

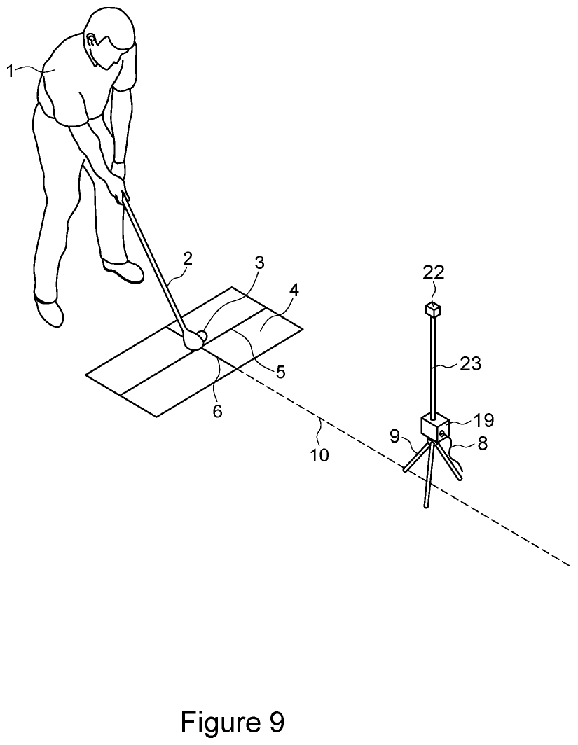

Reference is now made to FIG. 9 which shows a pictorial representation of a player and club, using a second embodiment of apparatus suitable for home-use without human assistance. The apparatus is shown in with-ball mode. The following is an index of the reference numerals used in the figure.
1. Player.
2. Club.
3. Ball, supported by a tee.
4. Playing mat.
5. Target direction line marked on the playing mat.
6. Face-on line marked on the playing mat.
8. Lead from enclosure to the computing device.
9. Face-on tripod support.
10. Face-on view, shown projected onto the ground.
19. Portion of enclosure encapsulating the lower stereo camera sensor, high-speed camera sensor, flash unit, processor unit and laser guide.
22. Portion of enclosure encapsulating the upper stereo camera sensor.
23. Hollow stem support between the upper and lower portions of the enclosure, spacing the cameras apart and protecting the connecting wires.

The apparatus is similar to that in the first described embodiment, except in this embodiment both camera sensors and the speed measuring means are encapsulated in a single enclosure supported by a tripod which straddles a face-on view of the tee and player.

The enclosure is of vertical elongate shape. One of the PE camera sensors is encapsulated in an upper portion of the enclosure and the other PE camera sensor is mounted in a lower portion of the enclosure, providing a stereoscopic view of the tee, player and club. The lower portion of the enclosure also encapsulates a high-speed camera sensor, flash unit, processor unit and laser guide. The upper portion of the enclosure is spaced apart from the lower portion by a light-weight hollow tube, which supports the upper portion and protects its connecting wires.

The speed measuring means comprises a high-speed camera, facing towards and focusing on the tee region. It commences operation as the clubhead approaches the impact position and ceases operation in the follow-through. Depending on camera type and lighting conditions, it may be assisted by a momentary flash or bright illumination of the tee region.

The system includes a laser guide and position checking system similar to that outlined in the first described embodiment. The PE system, kinetic prediction system and 3D model tracking system also operate in a similar manner to that outlined in the first described embodiment.

The second described embodiment has two potential relative advantages over the first embodiment. One of these is user convenience in setting up and operating a single encapsulated enclosure. The second is the close proximity of all of the measuring and processing devices to each other, obviating the need for providing either wireless communication or lengthy connecting wires between separate enclosures.

Positioning both cameras in a face-on view causes portions of the arms and club to be occluded in the later portions of the backswing and early portion of the downswing. However, this can be satisfactorily accommodated by giving special attention to training the PE system and the kinematic-to-kinetic machine learning system to track the arms and club through the occluded region, which is helped by the clubhead, clubshaft and at least one set of elbows and arms being visible to both cameras on either side of the occluded region in the backswing and subsequent downswing. The matter is also helped by the very small contribution to energy generation of the shoulders and arms in the occluded region. The arms and shoulders typically contribute less that a quarter of the energy generated in the downswing and only a small part of that typically occurs in the occluded region, typically no more than about 3% of total energy generated in the downswing.

### 4.3 Third Described Embodiment

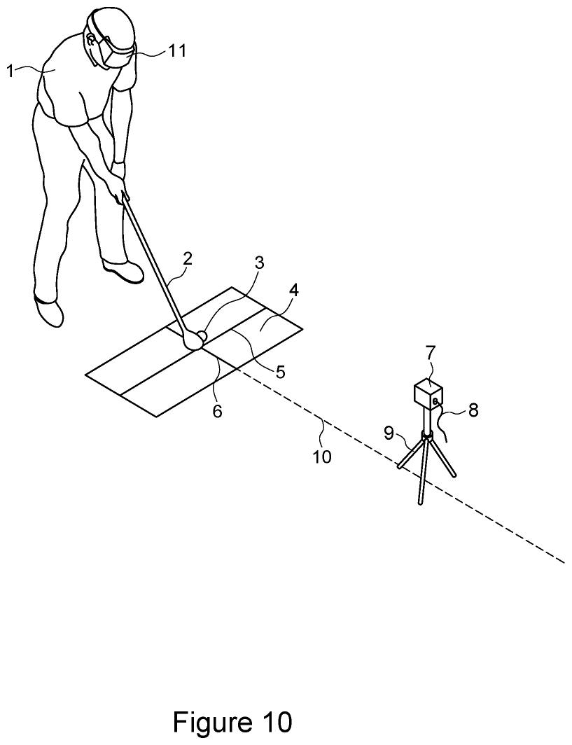

Reference is now made to FIG. 10 which shows a pictorial representation of a player and club, using a third embodiment of apparatus suitable for home-use without human assistance. The apparatus is shown in with-ball mode. The following is an index of the reference numerals used in the figure.
1. Player.
2. Club.
3. Ball, supported by a tee.
4. Playing mat.
5. Target direction line marked on the playing mat.
6. Face-on line marked on the playing mat.
8. Lead from enclosure to the computing device.
9. Face-on tripod support.
10. Face-on view, shown projected onto the ground.
20. Enclosure encapsulating the face-on camera sensor, high-speed camera, processor unit and laser guide.
21. AR/VR headset.

The apparatus is similar to that in the second described embodiments, except in this embodiment a single PE camera sensor, with a face-on view of the player and tee, is encapsulated in the enclosure and the enclosure is no longer elongate. The communication system may operate with or without a portable computer, depending on the capabilities of the AR/VR system which communicates with the player through a wearable device such as a headset. Measurement of clubhead speed and impact, use of a kinetic data machine learning system, use of a laser guide and position checking system, may all be carried out in the similar manner to that disclosed in the second described embodiment. Similar to the second described embodiment, the third described embodiment has an advantage over the first described embodiment of not requiring a second enclosure and thereby being of greater user convenience in setting up and operating the system.

The player also wears an AR/VR headset and information from the AR/VR system is used to augment information from the single PE camera, to assist in providing depth information and reducing occlusion. The term “AR/VR” is used to describe any type of immersive technology system, referred to by various names including “spatial computing”, “virtual reality” (VR), “augmented reality” (AR), “mixed reality”, (MR) and “extended reality” (XR). The PE and speed measurement arrangements will depend on the capabilities of the particular AR/VR system. Typically, the AR/VR system may provide information on the elevation and movement of the headset and therefore the player's head segment and neck joint. The AR/VR camera system may provide information on the relative position of the clubhead, at least a portion of the clubshaft, and also the markings on the playing mat, relative to the headset. This data is separately processed by the headset software and sent wirelessly to the ground-based processing system where it is used as additional data to provide depth and minimise occlusions for the PE ground-based camera system.

If the augmented information from the particular AR/VR system, which is employed in end-use, cannot compensate for the loss of depth information caused by using a single ground-based camera, a ground-based two-camera system, similar to that depicted in the second described embodiment in FIG. 9, may be used.

The AR/VR system potentially provides numerous relative benefits when used with a non-putting golf swing. These include its ability to provide very high-quality audio-visual instructions, realistic simulated surroundings and vibrant visual feedback.

### 5.0 Use in Commercial and Elite Applications

Similar apparatus to the embodiments already described, using PE systems, may be used in commercial applications, such as off-course golf centres or driving ranges. However, because there is no requirement for a player to set up the system, a greater number of cameras can be used to minimise occlusion, without set up or significant cost penalties. For example, a three-camera or four-camera PE system can be used such that no significant part of the player or club is occluded at any point in the swing.

Where required, the system may be arranged to optionally operate automatically or semi-automatically. Semi-automatic operation may be used to allow a human instructor provide additional instruction or explanation. Automatic operation may be used to allow the instructor to simultaneously preside over multiple student players, providing individual attention as required, but otherwise each student player using an individual set of apparatus with automatic operation. The human instructor may, if required, set the apparatus to run with programmed automatic operation tailored to the individual student player.

The PE system can also be adapted to suit high-level elite training and improvement. In one example, a three or four camera PE system is used as the motion capture system. The player stands on a pair of force plates during the swing and kinetic parameters are calculated using inverse dynamics, in accordance with methods and apparatus described in prior art WO 2013/04144. The PE system is also used to measure body segment inertial parameters of the player, which are required for inverse dynamics calculations. The body segment inertial parameters are measured by the PE system with the player assuming various relevant pose routines.

Systems which directly use inverse dynamics provide a higher level of accuracy than the machine learning prediction described earlier, which is of particular importance with elite players for two reasons. First, highly accurate player kinetic records over time are of more importance to elite players. Second, elite players are less likely to be fully represented in a training database because some parameters in their very highly accomplished play are more likely to be extreme values which fall outside the normal range of a PE system or kinetic prediction system which was trained on databases which did not comprise a wide range of high-level elite players.

### 6.0 Alternative Methods of Motion Capture

All of the methods discussed up to now have used PE with two or more cameras. Other methods may also be used including use of wearable sensors which track the movement of the player's segments during the swing. For example, the motion capture system may comprise multiple inertial sensors mounted on segments of the player. The sensors may comprise inexpensive IMU inertial sensors which track the 3D angular orientations of the player's body segments, over the very short time spans which occur in the swing, without occurrence of significant sensor drift errors. Changes in these values between any pair of segments connected by a joint provide the changes in 3D angle at the joint, from which the joint angular velocities and accelerations can be calculated over the swing. Because the system uses relative movements, precision is not required in sensor positioning on player segments. Accuracy is not affected if sensors change position slightly on the segments from swing to swing, provided the sensors do not change position during the swing. A simple IMU system can readily provide kinematic data required for the kinetic feedback required in upwardly disrupting discovery swings. Clubhead speed and time of impact can be measured by means already described for use with PE systems. Prediction of kinetic values from kinematic data using a trained machine learning system, as already described, can also be used.

Other motion capture systems include electromagnetic systems where electromagnetic sensor emitters, connected to player segments, are tracked in an electromagnetic field, and optical motion capture systems where markings or optical emitters on player segments are tracked by fixed cameras.

Although not currently considered practical, it is also possible that single-camera 3D PE, or 3D PE used with one or more smartphone cameras, may provide suitable methods of motion capture at some point in the future.

### 7.0 Summary of Key Advantages Over Coaching Techniques and Apparatus

Probably the most remarkable advantage of the present invention, over known coaching techniques and apparatus, is its ability to rapidly overcome the usual vehement resistance of the player's subconscious to experiment and discover new and improved subconscious movement patterns. This ability allows the present system to scientifically and methodically direct the player's subconscious to successfully discover and adopt ever-intensifying increases in swing strength, accuracy and consistency. This contrasts with conventional coaching which attempts to consciously impose coaching changes which usually do not properly fit the player's existing movement patterns and are resisted by the player's subconscious, usually resulting in very slow advancement, if at all, and poor learning retention.

A second remarkable advantage of the system apparatus is its ability to be successfully and conveniently automated. Although some systems based on coaching techniques have claimed successful automatic operation, these claims are invariably aspirational, with the evidence ultimately indicating that they cannot work successfully. Several problems arise when using coaching techniques, including the evident strong mismatch between the player's conscious and subconscious control systems. This hurdle does not arise with the system of the invention because the player improves by a process of subconscious discovery learning and an ability of the measurement apparatus to direct and use feedback parameters which strongly resonate with the operating system of the subconscious.

A further important advantage of the system is its evident ability to continually improve a player's non-putting swing up to the frontiers of the player's ultimate natural limits of strength and capability. There appears to be no other limit to the level of learning skill retention, with the directed discovery method of the invention appearing to be always capable of raising skill levels above the then-current level of retention. This has been observed in tests across a wide range of players, from beginner to accomplished, although elite players above scratch level have not yet been tested.

### 8.0 Motion Sequences Other than Non-Putting Golf Swings

The invention also provides an apparatus and computer-implemented method for improving motion sequences with high-energy-elements, other than non-putting golf swings. Examples of such motion sequences include baseball, tennis, cricket, hockey, ice-hockey, basketball, various games with ball kicking, boxing, martial arts, javelin throwing and various skilled movements which can be incorporated into electronic video gaming.

In the non-putting golf swing, the high-speed-element is the downswing, with an implement, which comprises the club, with energy generated internally across the joints of the body. The clubhead comprises the distal end of a kinetic chain running from the clubhead back through the connected segments of the player's body. The high-speed-element ends at impact, where the club impacts a projectile, which is a golf ball.

Similar involvements of player, implement and projectile in a high-energy-element occur in batting in baseball or cricket, where the implement is a bat, and the projectile is a ball. They also occur in tennis where the implement is a racquet, and the projectile is a ball.

Further examples, which are less similar to a golf swing, involve the player and a projectile. The distal end of the kinetic chain comprises one or two body segments and the projectile. A high-energy-element is completed when the projectile is released from the body segment or body segments. These examples include pitching or bowling in baseball or cricket, respectively, where the body segment is a hand or lower arm, and the projectile is a ball.

They also include javelin or weight throwing, where the body segment is a hand or lower arm and the projectile is a javelin or weight.

Yet further examples, which are less similar to a golf swing, occur, where the distal end of the kinetic chain comprises a body segment, and a high-energy-element is completed when impact occurs between the body segment and a projectile. These examples include ball kicking, where the body segment is a shod foot or lower leg, and the projectile is a ball.

Further examples of these, which are less similar to a golf swing, occur where the distal end of the kinetic chain comprises a body segment, and a high-energy-element is completed when impact occurs between the body segment and a hit-object. One such example is given in throwing a punch in boxing, where the body segment is a hand or fist, and the hit-object is an opponent player. Another such example is given by hitting a martial-arts strike, where the body segment is a hand or foot, and the hit-object is an opponent player.

The parameters which are improved in these various high-energy-elements are very similar to those improved in the non-putting golf downswing with respect to the invention. This arises because they are all primarily concerned with energy generated across the joints of the human body and transferred to the distal end of the kinetic chain of body segments or transferred to the distal end of the kinetic chain of body segments, implement and/or projectile, where an implement and/or projectile, respectively, is involved. Furthermore, in the aforementioned high-energy-elements, where the activity is carried out in an accomplished manner it will utilise energy generation widely across the body, similar to an accomplished golf downswing. Another advantageous similarity to the golf swing is that the high-energy-elements are of an intermittent nature, similar to the golf downswing, drawing on an intermittent use of high-energy levels, as opposed to an activity which requires more constant and sustained use of generated energy, such as cycling, swimming or running. It is a further insight of the invention that these various similarities to the non-putting golf swing allow similar methods and apparatus to be used for measuring and improvement through discovery learning. The apparatus or computer-implemented methods used in measuring or improving these high-energy-elements, with judicious modification by persons skilled in the art, may be treated mutatis mutandis to methods or apparatus described for improving a non-putting golf swing.

The following is a list of corresponding terms between a golf swing and a similar motion sequence which may appear in the claims accompanying this description.

| | |
|---|---|
| Golf swing | Motion sequence. |
| Swing | Motion sequence. |
| Downswing | High-energy-element. |
| Club | Implement. |
| Ball | Projectile. |
| Address | Position before the start of a motion sequence. |
| Takeaway | Start of a motion sequence. |
| TOB | Start of the high-energy-element. |
| Impact | Sometimes equivalent to the end of the high- |
| | energy-element. |
| Playing mat | Playing surface. |

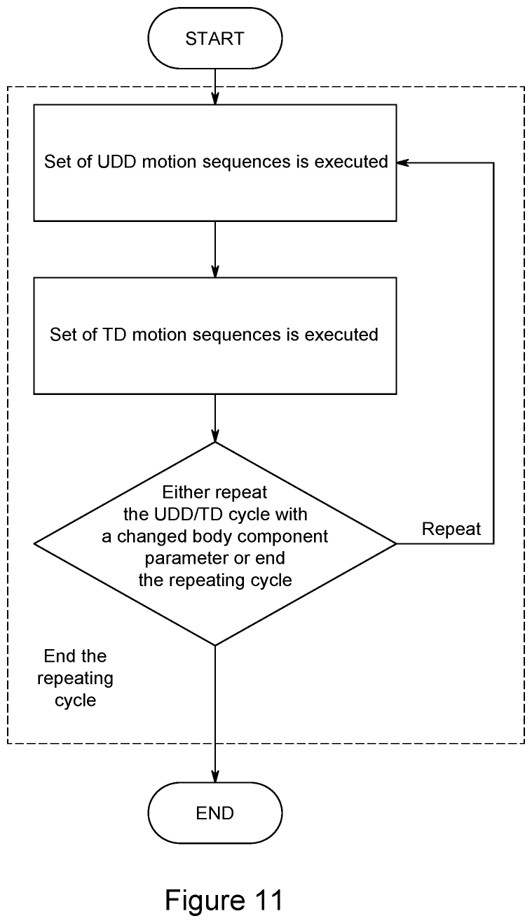

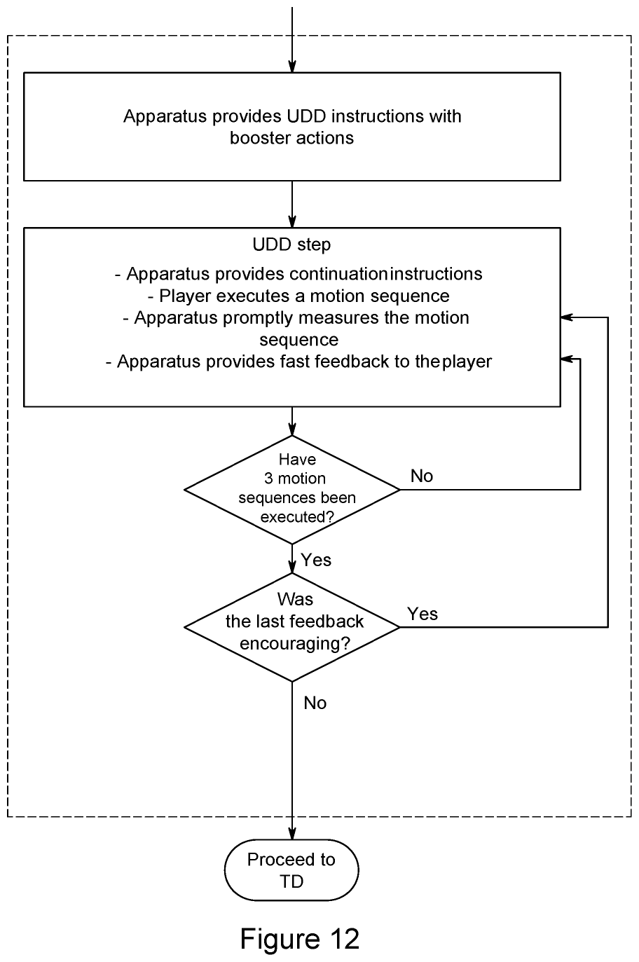

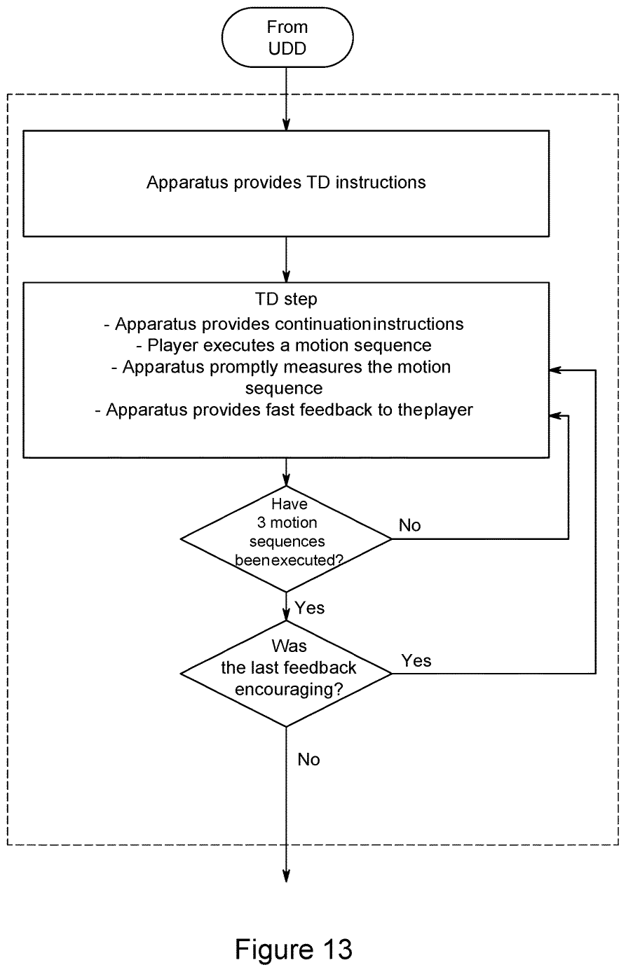

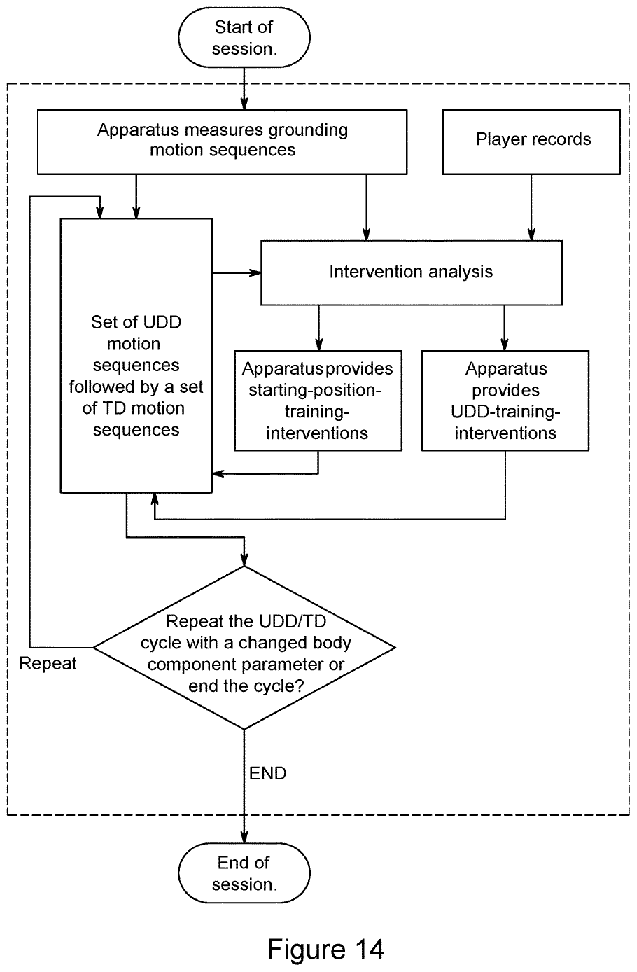

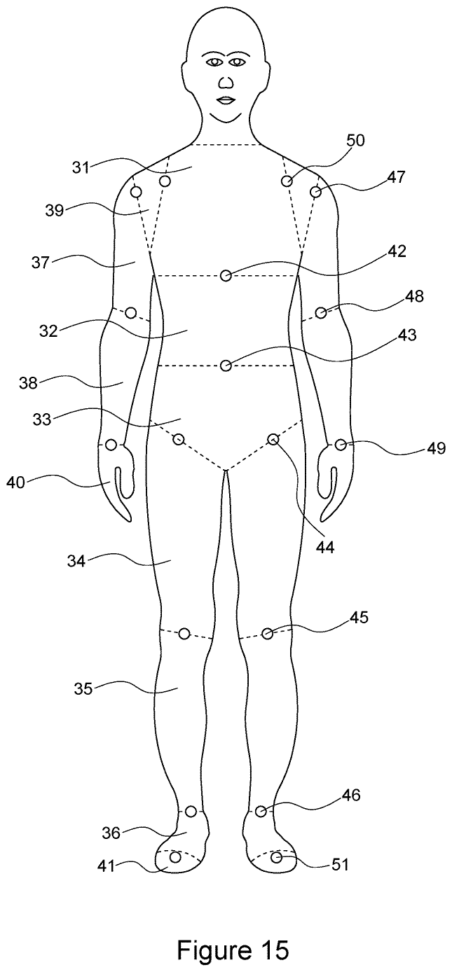

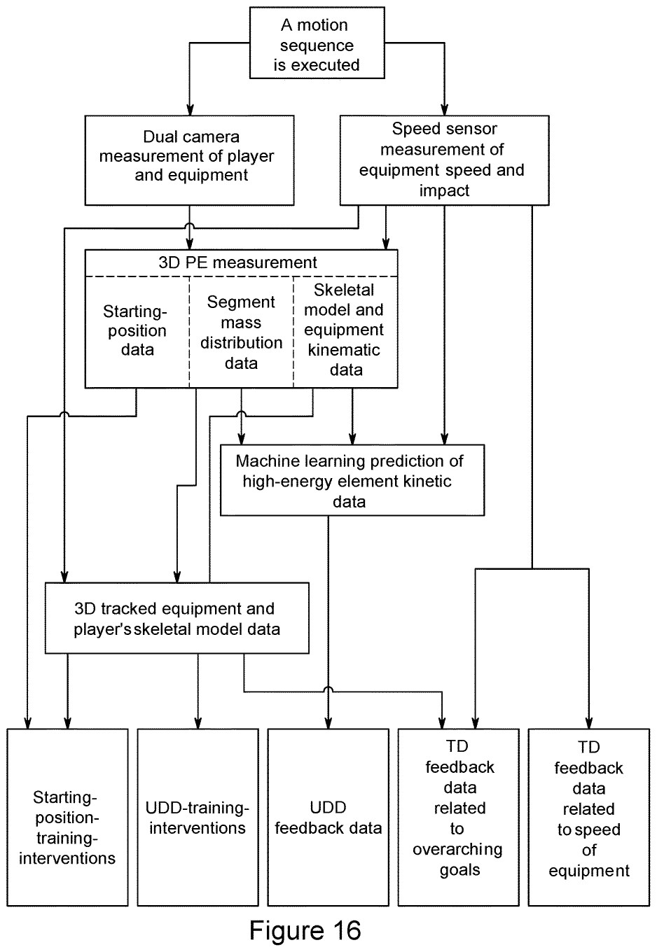

Reference is made to FIGS. 11, 12, 13, 14, 15 and 16, showing flow charts and model components relevant to a motion sequence, which should also be treated mutatis mutandis with the explanations of FIGS. 1, 2, 3, 4, 5 and 8, respectively, showing flow charts and model components relevant to a non-putting golf swing. In FIG. 16, the term “equipment” relates to the relevant high-speed item at the distal end of the kinetic chain, such as the implement, projectile or body segment, as explained earlier.

In summary, an encapsulated dual-camera apparatus (19), with machine-learning 3D motion-capture and machine-learning measurement of energy generation within the body, captures live data on a player's (1) non-putting golf swing. Feedback from the energy generation data is used to drive a highly novel directed discovery learning process. The energy generation approach strongly resonates with the player's subconscious system and rapidly overcomes its usual vehement resistance to experiment with and discover new and improved subconscious movement patterns. This allows the apparatus to scientifically and methodically direct it to successfully discover and adopt ever-intensifying increases in swing strength, accuracy and consistency. The apparatus is fully automatic, easy to use and operates without body sensors or special clothing. It can be optionally used with a real (3) or virtual ball.

It is to be understood that the invention is not limited to the specific details described herein which are given by way of example only and that various modifications and additions are possible without departing from the scope of the invention as defined in the appended claims.

1. A computer implemented method for improving a golf swing, comprising:
instructing a player to augment the magnitude of one or more predetermined energy generation parameters of a predetermined body component during a swing;
upwardly disrupting subconscious movement patterns of the player by endeavouring to elevate said predetermined energy generation parameters;
leveraging the upward disruption to amplify energy generation parameters of another body component of the player through a type of directed discovery process, referred to as an upwardly disrupting discovery process; and
using a measuring means to measure a modification of the one or more predetermined energy generation parameters.

2. The computer implemented method for improving a golf swing according to claim 1, wherein the method includes furnishing feedback to the player prior to the player taking a subsequent swing.

3. The computer implemented method as claimed in claim 1 wherein, during an upwardly disrupting swing, the disruption to the player's subconscious movement patterns includes the use of one or more booster actions to amplify predetermined energy generation parameters of the predetermined body component by way of an upwardly disrupting discovery process.

4. The computer implemented method as claimed in claim 1 wherein, during a tempering swing, the method incorporates one or more tempering parameters, the tempering swing promptly follows the completion of one or more upwardly disrupting swings, ensuring swing continuity and preserving the lingering effect of the upwardly disrupting swings into the subsequent tempering swing, with the tempering parameters being directed towards one or more overarching goals.

5. The computer implemented method as claimed in claim 4 wherein, the method includes one or more of the following steps:
instructing the player on the overarching goals,
using a measuring means to measure a modification of the one or more tempering parameters, and
providing feedback on the achievement of the overarching goals.

6. The computer implemented method as claimed in claim 1, wherein the method comprises a player performing alternating sets of upwardly disrupting and tempering swings, utilizing both the upwardly disrupting discovery process and a tempering discovery process, organizing sets with minimum numbers of swings, and instructing the player to maintain consistency in their predetermined body component, energy generation parameters, and relevant booster actions during the course of an upwardly disrupting discovery set, wherein the step includes altering the targeted body component in each new set of upwardly disrupting discovery swings.

7. The computer implemented method as claimed in claim 1, wherein, during completion of one or more upwardly disrupting swings, the method includes the step of representing the player as a model of rigid body segments and corresponding muscle groups interconnected by joints, including analysing energy generation parameters linked to a movement of the joints associated with the predetermined body components of the model.

8. The computer implemented method according to claim 1 wherein, the method includes the step of enhancing one or more energy generation parameters associated with the movement of the joints during a downswing, including, but not limited to, one or more of the following components in the downswing: joint energy magnitude; angular displacement; torque magnitude; a measure of the commencement of an individual positive joint energy.

9. The computer implemented method according to according to claim 8, the downswing components of joint energy magnitude, angular displacement, torque magnitude, and a measure of the commencement of an individual positive joint energy, are positive components; where a positive component is understood to mean one which occurs over periods when torque is positive and assists rather than retards angular displacement at the predetermined individual joint.

10. The computer implemented method according to claim 1 wherein, during completion of one or more upwardly disrupting swings, the method includes selecting one or more predetermined body components of the player, including, but not limited to, one or more of the following joints and corresponding muscle groups: left hip; right hip; lumbar; thorax; right elbow; left knee or left knee and left ankle, right shoulder or right shoulder and right shoulder girdle, and focusing the method on these body components to improve the swing of the player.

11. The computer implemented method according to claim 3, wherein the one or more booster actions to amplify the energy generation parameters of the predetermined body component include one or more of the following:
instructing the player to use and exaggerate highly energetic movements involving the predetermined body component during the downswing,
instructing the player to exaggerate angular displacements involving the predetermined body component during the backswing or downswing,
instructing the player to exaggerate positions involving the predetermined body component in the top-of-backswing or address,
instructing the player to visualize the relevant predetermined body component taking a leading role in the swing,
wherein such instructions are delivered in a concise manner, as audio instructions, and using an encouraging tone when delivering such instructions as audio instructions.

12. The computer implemented method according to claim 1, wherein the method further includes using feedback means to provide feedback to the player, wherein the feedback includes, but is not limited to, audio qualitative feedback such as improved, similar or not as good, audio applause and cheering based on the degree of improvement achieved in the swing, and visual numerical feedback.

13. The computer implemented method as claimed in claim 1, wherein the method involves utilizing a virtual ball target means to alleviate player anxiety and bolster focus on crucial instructions, including employing one or more of the following techniques, replacing a ball with a virtual ball target means, delivering feedback determined by the velocity of a clubhead upon impact with either a ball or a virtual ball target means, supplying feedback based on both clubhead speed upon impact with a ball or virtual ball target means alongside further swing accuracy measurements, and offering feedback with the flexibility to choose between it being reliant on clubhead speed upon impact alone or on both clubhead speed upon impact and additional swing accuracy measurements.

14. (canceled)

15. (canceled)

16. An apparatus for improving a golf swing, comprising:
means for instructing the player to perform alternating sets of upwardly disrupting and tempering swings,
means for utilizing both the upwardly disrupting discovery process and the tempering discovery process,
means for organizing sets with minimum numbers of swings,
means for instructing a player to maintain consistency in predetermined body components, energy generation parameters, and relevant booster actions during the course of an upwardly disrupting discovery set, and
means for altering the targeted body component in each new set of upwardly disrupting discovery swings.

17. The apparatus for improving a golf swing as claimed in claim 16, wherein the apparatus includes one or more of the following:
means for identifying and analysing positive downswing components which occur over periods when torque is positive and assists rather than retards angular displacement at predetermined individual joints including one or more of the positive downswing components of joint energy magnitude, angular displacement, torque magnitude, and a measure of the commencement of an individual positive joint energy.

18. The apparatus for improving a golf swing as claimed in claim 16, wherein the apparatus includes one or more of the following:
means for selecting one or more predetermined body components of the player, including, but not limited to, joints and corresponding muscle groups, and
means for focusing on the selected body components to improve the player's swing.

19. The apparatus for improving a golf swing as claimed in claim 16, wherein the apparatus includes one or more of the following:
means for instructing exaggerated highly energetic movements involving predetermined body components during the downswing,
means for instructing exaggerated angular displacements during the backswing or downswing,
means for instructing exaggerated positions during the top-of-backswing or address,
means for visualizing relevant predetermined body components taking a leading role in the swing, and
means for delivering concise audio instructions with an encouraging tone.

20. An apparatus for improving a golf swing, the apparatus comprising:
means for instructing a player to increase the magnitude of one or more predetermined energy generation parameters of a predetermined body component during a swing,
means for upwardly disrupting subconscious movement patterns of the player by attempting to raise said predetermined energy generation parameters,
means for leveraging the upward disruption to amplify energy generation parameters of another body component of the player through a directed discovery process, referred to as an upwardly disrupting discovery process, and
a measuring means to gauge a modification of the one or more predetermined energy generation parameters.

21. The apparatus for improving a golf swing as claimed in claim 20, further comprising feedback means to provide feedback to the player before the player initiates a subsequent swing.

22. The apparatus for improving a golf swing as claimed in claim 20, wherein the measuring means comprises one of the following types of motion capture means:
a three-dimensional pose estimation means incorporating one or more camera means and a machine learning means, to estimate key points of the club and the player model of segments and joints,
a two-dimensional pose estimation means with one or more camera means and a machine learning means, estimating key points of the club and the player model of segments and joints,
a motion capture means with multiple inertial sensors mounted on segments of the club and the player,
an electromagnetic motion capture means with electromagnetic sensor emitters, connected to club and player segments, tracked in an electromagnetic field, and
an optical motion capture means with markings or optical emitters on club and player segments tracked by fixed cameras.

23-72. (canceled)
